(19) United States
(12) Patent Application Publication
(10) Pub. No.: US 2023/0394644 A1
(43) Pub. Date: Dec. 7, 2023

(54) READINESS STATE DETECTION FOR PERSONAL PROTECTIVE EQUIPMENT

(71) Applicant: 3M INNOVATIVE PROPERTIES COMPANY, St. Paul, MN (US)

(72) Inventors: Marie D. Manner, St. Paul, MN (US); Lydia R. Carlson, St. Paul, MN (US); Joseph P. Kronzer, Shoreview, MN (US); Jonathan D. Gandrud, Woodbury, MN (US); Longin J. Kloc, Charlotte, NC (US); Shane A. Hainey, Cottage Grove, MN (US); Matthew J. Blackford, Lake Elmo, MN (US); Caroline M. Ylitalo, Stillwater, MN (US); Muhammad J. Afridi, Woodbury, MN (US); Michael A. McCoy, St. Paul, MN (US)

(21) Appl. No.: 18/249,113

(22) PCT Filed: Oct. 4, 2021
(86) PCT No.: PCT/IB2021/059087

§ 371 Date: Apr. 14, 2023

Related U.S. Application Data
(60) Provisional application No. 63/260,734, filed on Aug. 31, 2021.
(60) Provisional application No. 63/092,842, filed on Oct. 16, 2020.

(51) Int. Cl. G06T 7/00; G06V 10/764; G06V 10/774; G06Q 10/20

(52) U.S. Cl. CPC G06T 7/0004; G06V 10/765; G06V 10/774; G06Q 10/20; G06T 2207/20081

(57) ABSTRACT

A personal protective equipment (PPE) interrogation device that uses auditory or visual data to ascertain a readiness state of the article of PPE. The auditory or visual data come from an inspection of the article of personal protective equipment in advance of determining whether the article ready for use.

### TECHNICAL FIELD

The present disclosure relates to the field of personal protection equipment. More specifically, the present disclosure relates to personal protection equipment that provide acoustic or visual signals that may be interpreted as electronic data to ascertain the readiness of the article of personal protective equipment.

### BACKGROUND

When working in areas where there is known to be, or there is a potential of there being, dusts, fumes, gases, airborne contaminants, fall hazards, hearing hazards or any other hazards that are potentially hazardous or harmful to health, it is common for a worker to use personal protection equipment (PPE), such as respirator or a clean air supply source. While a large variety of personal protection equipment are available, some commonly used devices include powered air purifying respirators (PAPR), self-contained breathing apparatuses (SCBAs), fall protection harnesses, earmuffs, face shields, and welding masks. For instance, a PAPR typically includes a blower system comprising a fan powered by an electric motor for delivering a forced flow of air through a tube to a head top worn by a worker. A PAPR typically includes a device that draws ambient air through a filter, forces the air through a breathing tube and into a helmet or head top to provide filtered air to a worker's breathing zone, around their nose or mouth. In some examples, various personal protection equipment may generate various types of data.

Many regulatory agencies around the world require employers to equip workers with PPE to protect workers on the job. The type of PPE required is dependent on the type of hazards the work is exposed to while performing the job. For example, workers who work at heights may be at risk of falling, therefore, they often wear fall protection equipment. Another example is fire fighters, who are often equipped with masks, fire resistant/high temperature tolerant clothing and air packs to supply breathing air.

Regular inspection of PPE is typically required to ensure the PPE is in working order and will provide protection to workers. For example, a fall protection harness that is frayed may break during a fall resulting in serious injury and even death. Therefore, visual inspection for frays or cuts in the harness is required by regulations in some countries to ensure worker safety.

Typically, manufacturers provide inspection check lists with the suggestion that workers should complete a relevant PPE inspection as needed or on a schedule of some sort. However, there is no oversight to ensure that manually completed check lists reflect actual completion of suggested inspection steps.

### SUMMARY

Articles, methods, and systems for using an interrogation device, such as a smart phone, to aid in inspecting an article of personal protective equipment (PPE) to determine a readiness state of a component of the article, or for the overall article itself. The readiness state is indicative of whether the component or article of PPE is ready for a given use, such as being deployed and used in a hazardous environment.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a drawing of an article of personal protective equipment having a gauge.

FIG. 2 is a drawing showing a gauge as shown in FIG. 1 in two different states.

FIG. 3 illustrates an example system including an interrogation device (a mobile computing device), a set of personal protection equipment communicatively coupled to the mobile computing device, and a personal protection equipment management system communicatively coupled to the mobile computing device, in accordance with embodiments described in this disclosure.

FIG. 4 is a system diagram of a personal protective equipment readiness assessment system.

FIG. 5 is a flow chart illustrating an exemplary process a user would use in conjunction with the PPE readiness assessment system to perform a readiness assessment on an article of personal protective equipment, or a component thereof.

FIG. 6 is an application layer diagram showing one model implementation of a personal protective equipment monitoring system as shown in FIG. 3.

FIG. 7 is a picture of a gas cylinder associated with an article of PPE, having an analog gauge.

FIG. 8 is a picture of a user interface with indicia assisting a user in positioning an image acquisition device for acquiring a picture of an article of PPE.

FIG. 9 is a resulting image from the picture shown in FIG. 8, with analysis overlay.

FIG. 10 is a picture of a further type of analog gauge.

FIG. 11 is picture of the gauge shown in FIG. 10, graphically showing the image analysis module identifying a dial, or needle, associated with it.

FIG. 12 is a picture of a strap, or lanyard, that is damaged by a tear.

FIG. 13 is a picture of a strap that is damaged by burns.

It is to be understood that the embodiments may be utilized, and structural changes may be made without departing from the scope of the invention. The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Inspections of personal protective equipment (PPE) is typically mandated by various local, state, and federal regulations. Before using particular articles of PPE, such as a self-contained breathing apparatus as would be used by a firefighter, a user needs to ensure that the article of PPE is complete and functioning properly. Therefore, the user typically conducts a readiness assessment by stepping through a checklist or other documented procedure. Along the way, the user will typically be asked to mark or otherwise indicate that various pieces of equipment have been checked, then somehow sign off on the overall readiness assessment at completion. These readiness assessments can be quite involved, sometimes comprising many steps which can take 5-15 minutes. Examples from one such readiness assessment, this particular one involving the regulator component of an SCBA for firefighters, are below:

Regulator Inspection
Regulator controls, where present, checked for damage and proper function
Pressure relief devices checked visually for damage
Housing and components checked for damage
Regulator checked for any unusual sounds such as whistling, chattering, clicking, or rattling during operation
Regulator and bypass checked for proper function when each is operated
Inspect the HUD for damage. Verify that the rubber guard is in place and is not torn or damaged
Observe the air supply indicator lights of the HUD and verify that they light properly in descending order
If the hose to the mask-mounted regulator is equipped with a quick-disconnect, inspect both the male and female quick-disconnects
Pressure Indicator Inspection
Pressure indicator checked for damage
Cylinder pressure gauge and the remote gauge checked to read within 10 percent of each other

Readiness assessments and associated sign-offs are often done by paper and writing instrument, but can also be facilitated using electronic means, for example a smart phone. In such an embodiment, a user would initiate a readiness assessment and an app would step the user through required inspection steps, then log various metadata associated with the inspection and its completion.

At times, users performing the readiness assessment may, in the name of expediency, skip required readiness steps, and sign-off on the readiness assessment as if they had successfully performed the skipped readiness steps. Such non-compliance is a broad industry problem, and exists when readiness assessments are facilitated by both paper and electronic means.

The present disclosure proposes novel systems and methods for better ensuring compliance with readiness assessment tasks for articles of PPE. As used in this disclosure, PPE refers to articles worn by a user that protect the user against environmental threats. The threats could be contaminated air, loud noises, heat, fall, etc. Though these systems and methods may be used for any type of suitable PPE, they may prove to be most beneficial to articles of PPE that have more rigorous and involved readiness assessments, which often coincide with articles of PPE where defects can have substantial consequences related to personal injury or death. Examples of such PPE include self-contained breathing apparatuses (SCBAs), which are used in firefighting to provide respiration facilities to a user, harnesses, or self-retracting lifelines (SRLs), which allow a user to move about a worksite at heights tethered to a safety member, but will arrest a fall event. PPE may also refer to respirators or hearing protection devices such as ear muffs.

The present disclosure provides systems and methods that allow a user to perform a readiness assessment with the assistance of, for example, a smart phone or other interrogation device, where certain of the steps in the readiness assessment are proven by input from either the microphone or the image sensors onboard the interrogation device. In one embodiment, microphones would receive an audio signal associated with one of the inspection steps, the audio signal being processed onboard the interrogation device (or in one embodiment on a disparately located computer system, such as in the cloud), to determine whether the step in the readiness assessment was successfully completed.

In one embodiment, image sensors would produce an image or series of images (video) associated with one of the inspection steps, the image or series of images being processed onboard the interrogation device (or in one embodiment on a disparately located computer system, such as in the cloud), to determine whether the step in the readiness assessment was successfully completed.

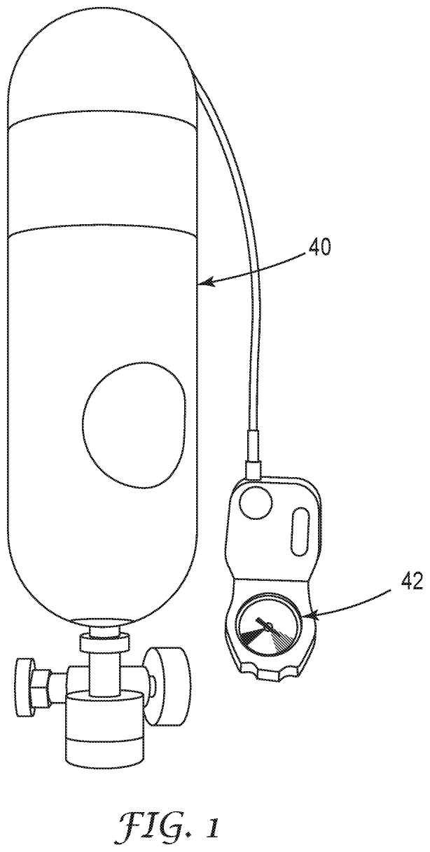

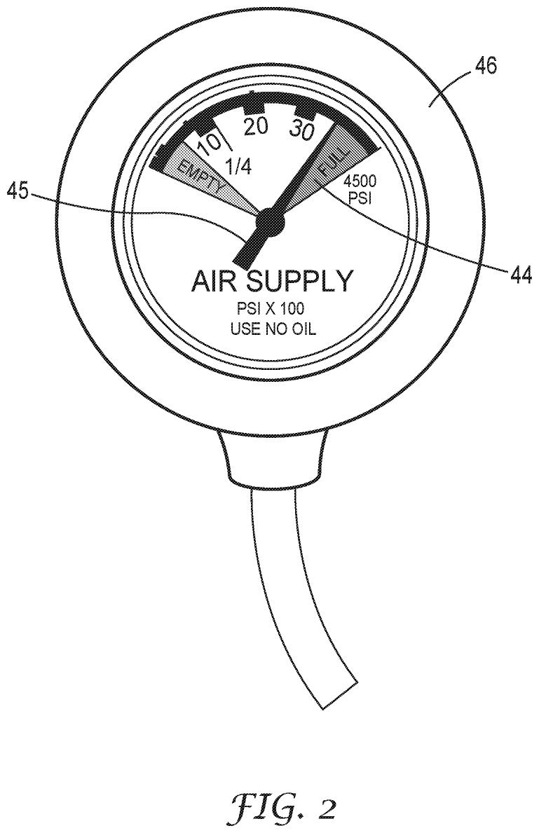

For example, in reference to FIG. 1, SCBA 40 as would be used by a firefighter is shown. During a readiness assessment of this asset, a user would inspect many components of the SCBA, including inspecting the readout of pressure gauge 42, which indicates the pressure in the air cylinder, and are shown in greater detail in FIG. 2. FIG. 2 shows pressure SCBA pressure gauge 46, having an analog dial 45, which is shown to be associated with a full cylinder (though on the low end of full), because the dial points to full-related dial indicia 44. In one embodiment described further below, instead of or in addition to a user manually inspecting the pressure gauge and recording its readout manually, a user would use an interrogation device, preferably a smart phone, and use the smart phone's image acquisition system, such as its camera, to take a picture of the face of the gauge. The picture would then be processed by the onboard processor to extract readiness state related information from the gauge. In this example, such readiness state related information could comprise, for example, that the gauge is associated with a full air cylinder, an empty cylinder, and/or the particular pressure being read shown by the dial. Other visual indicators concerning the readiness state of the article of PPE may be similarly interpreted by an interrogation device using a camera or other image acquisition apparatus—for example LED lights that indicate the state of an article of PPE or a component of the article of PPE could be ascertained using this method, in order to determine an overall assessment of the readiness state of the article of PPE. The SCBA's face-mask could also have lights, such as LEDs, that provide readiness-related information. These can also be used, via an interrogation device, to ascertain the readiness of the article of PPE as part of a readiness check sequence. More information about the processing of the picture is described below.

As an example of inspection events having an audio component, certain inspection steps associated with types of PPE have associated audio artifacts which can be sensed by microphones onboard the interrogation device. For example, in the case of an SCBA, one inspection step exercising one or more of the valves that control air flow, which results in pressurized air egressing from the cylinder. This step has a characteristic “whoosh” and subsequent nozzle rattle sound if done successfully. Another example is a Personal Alert Safety System (PASS) alarm going off on certain equipment, sounds associated with extending or retracting a self-retracting lifeline (SRL), or a vibration alert on certain pieces of PPE. In one embodiment, during this step an app on the interrogation device would receive input from the microphone during this inspection step and would sense that it was successfully completed.

In cases of both the picture inspection and the audio inspection, data associated with these events, including the actual pictures/video taken or the audio recorded may be archived for later audit or verification purposes.

The present disclosure, then, provides a system having an article of personal protection equipment (PPE); at least one component of the PPE that is configured to provide acoustic or visual indicia of PPE readiness; and an interrogation device, preferably a smart phone, which comprises one or more computer processors; a memory comprising instructions that when executed by the one or more computer processors cause the one or more computer processors to: receive, from the an microphone or camera, audio or picture data associated with PPE readiness state. The data is then analyzed to determine a PPE readiness state.

The term readiness state, then, as used in this disclosure, refers to data indicative of whether and potentially the degree to which either a component of an article of PPE or the entirety of the article of PPE is ready for a given use. Typically, the given use would be, for example, use as intended in the field. In a firefighting SCBA context, this would mean the SCBA is ready to be used in a firefighting environment. However, other given uses are possible—for example, articles of PPE could have a readiness assessment associated with other use cases such as short term, intermediate term, and long-term storage. Certain state related information, such as whether various valves should be left open or closed, or whether gas containing cylinders should be stored full or empty or in between, whether equipment is of requisite level of cleanliness, could all be altered based on the given use. Sometimes a readiness state may be in the form of a Boolean, but more typically the Boolean yes/no determination would be based on an algorithmic interpretation of the data that underlies the readiness state. For example, the analysis of the readiness state of a gas cylinder, by analyzing an analog gauge as shown in FIG. 2, may yield a pressure reading extracted from the face of the analog gauge, showing that the cylinder is less than full, but is acceptable. This pressure reading could then be algorithmically interpreted, given the intended use of the equipment as a “pass” or a “fail”. Alternatively, the algorithm that is used to interpret the gauge could simply be applying a machine learning algorithm that has been trained with myriad pictures of gauges that are associated with a state that is acceptable (i.e., “pass”) and unacceptable (i.e., “fail”), and the analysis algorithm itself may return this determination. In such a scenario, a user entity, such as a fire department or regional fire authority, could provide pictures or auditory samples of “pass” or “fail” states, which could be used for machine learning training.

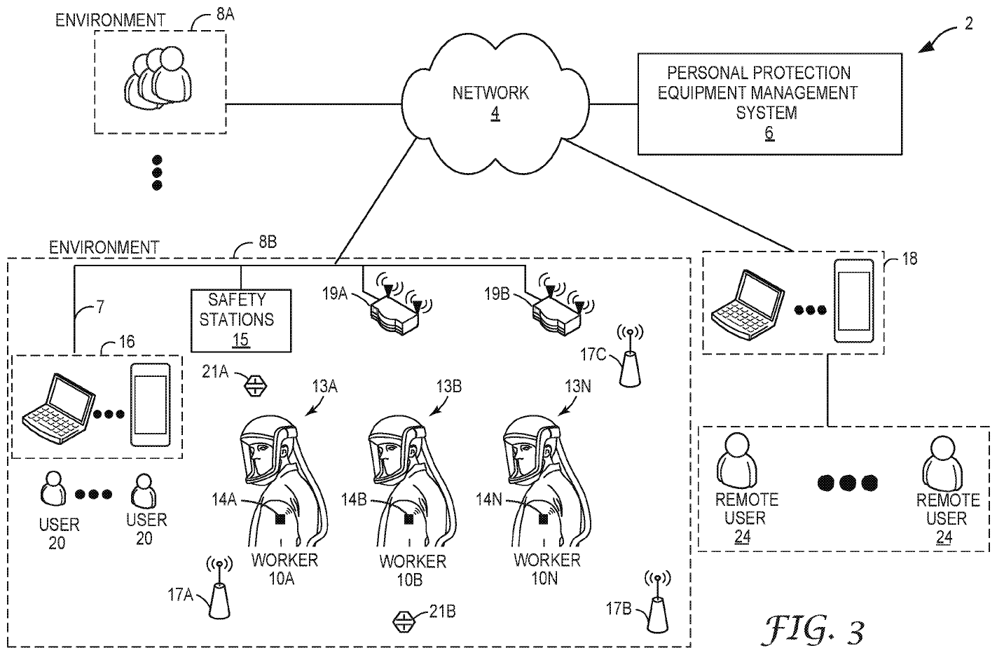

FIG. 3 is a block diagram illustrating an example system 2, in accordance with various techniques, systems, and methods described in this disclosure. As shown in FIG. 3, system 2 may include a personal protection equipment management system (PPEMS) 6. PPEMS 6 may provide data acquisition, monitoring, activity logging, reporting, predictive analytics, PPE control, and alert generation, to name only a few examples. For example, PPEMS 6 includes an underlying analytics and safety event prediction engine and alerting system in accordance with various examples described herein. In some examples, a safety event may refer to activities of a worker using PPE, a condition of the PPE, or an environmental condition (for example, which may be hazardous). In some examples, a safety event may be an injury or worker condition, workplace harm, or regulatory violation. For example, in the context of fall protection equipment, a safety event may be misuse of the fall protection equipment, a worker of the fall equipment experiencing a fall, or a failure of the fall protection equipment. In the context of a respirator, a safety event may be misuse of the respirator, a worker of the respirator not receiving an appropriate quality and/or quantity of air, or failure of the respirator. A safety event may also be associated with a hazard in the environment in which the PPE is located. In some examples, an occurrence of a safety event associated with the article of PPE may include a safety event in the environment in which the PPE is used or a safety event associated with a worker using the article of PPE. In some examples, a safety event may be an indication that PPE, a worker, and/or a worker environment are operating, in use, or acting in a way that is normal or abnormal operation, where normal or abnormal operation is a predetermined or predefined condition of acceptable or safe operation, use, or activity. In some examples, a safety event may be an indication of an unsafe condition, wherein the unsafe condition represents a state outside of a set of defined thresholds, rules, or other limits configured by a human operator and/or are machine-generated. In some examples, a safety event may include verification, tracking and/or recording of inspection of PPE for use in the workplace.

At times, before use, the PPEMS 6 may be used to ensure compliance with inspections of PPE equipment. Such inspections may be required by regulatory agencies, such as OSHA, site management, the National Fire Prevention Association (NFPA) or other agencies. Inspections of PPE may have various different objectives; for example an inventory of PPE is a form of an inspection to ascertain if various assets exist and are properly accounted for. Another type of inspection is a readiness inspection, which is done to ensure the article of PPE is ready for use.

Examples of PPE include, but are not limited to respiratory protection equipment (including disposable respirators, reusable respirators, powered air purifying respirators, and supplied air respirators), self-contained breathing apparatus, protective eyewear, such as visors, goggles, filters or shields (any of which may include augmented reality functionality), protective headwear, such as hard hats, hoods or helmets, hearing protection (including ear plugs and ear muffs), protective shoes, protective gloves, other protective clothing, such as coveralls and aprons, protective articles, such as sensors, safety tools, detectors, global positioning devices, mining cap lamps, fall protection harnesses, self-retracting lifelines, heating and cooling systems, gas detectors, and any other suitable gear.

As further described below, PPEMS 6, in various embodiments, provides an integrated suite of personal safety protection equipment management tools and implements various techniques of this disclosure. That is, PPEMS 6 may provide an integrated, end-to-end system for managing personal protection equipment, e.g., safety equipment, used by workers 10 within one or more physical environments 8 (8A and 8B), which may be construction sites, mining or manufacturing sites, burning or smoldering buildings, or any physical environment where PPE is used. The techniques of this disclosure may be realized within various parts of computing environment 2.

As shown in the example of FIG. 3, system 2 represents a computing environment in which a computing device within of a plurality of physical environments 8A-8B (collectively, environments 8) electronically communicate with PPEMS 6 via one or more computer networks 4. Each of physical environment 8 represents a physical environment, such as a work environment, in which one or more individuals, such as workers 10, utilize personal protection equipment while engaging in tasks or activities within the respective environment.

In this example, environment 8A is shown as generally as having workers 10, while environment 8B is shown in expanded form to provide a more detailed example. In the example of FIG. 3, a plurality of workers 10A-10N (“workers 10”) are shown as utilizing respective respirators 13A-13N (“respirators 13”), which are depicted as just one example of PPE that could be used alone or together with other forms of PPE in environment 8B.

As further described herein, each article of PPE, such as respirators 13, may include embedded sensors or monitoring devices and processing electronics configured to capture data in real-time as a worker (e.g., worker) engages in activities while wearing the respirators. For example, as described in greater detail herein, each article of PPE, such as respirators 13, may include a number of components (e.g., a head top, a blower, a filter, and the like), which may include a number of sensors for sensing or controlling the operation of such components. A head top may include, as examples, a head top visor position sensor, a head top temperature sensor, a head top motion sensor, a head top impact detection sensor, a head top position sensor, a head top battery level sensor, a head top head detection sensor, an ambient noise sensor, or the like. A blower may include, as examples, a blower state sensor, a blower pressure sensor, a blower run time sensor, a blower temperature sensor, a blower battery sensor, a blower motion sensor, a blower impact detection sensor, a blower position sensor, or the like. A filter may include, as examples, a filter presence sensor, a filter type sensor, or the like. Each of the above-noted sensors may generate usage data, as described herein. For some sensors, it may be possible to receive data from them via an electronic download, as for example using Bluetooth. But for many sensors designed to work in harsh environments with or possibly without power, analog sensors are still frequent. Also, many inspection steps completed in the assessment of a readiness state of an article of PPE involve inspecting aspects of the PPE that do not comprise sensors. An example of this would be, for example, a step that requires a user to inspect a harness strap for signs of wear or fraying.

In addition, each article of PPE, such as respirators 13, may include one or more output devices for outputting data that is indicative of operation of articles of PPE, such as respirators 13, and/or generating and outputting communications to the respective worker 10. For example, articles of PPE, such as respirators 13, may include one or more devices to generate audible feedback (e.g., one or more speakers), visual feedback (e.g., one or more displays, light emitting diodes (LEDs) or the like), or tactile feedback (e.g., a device that vibrates or provides other haptic feedback). The PPE may also include various analog or digital gauges.

In general, each of environments 8A and 8B include computing facilities (e.g., a local area network) by which articles of PPE, such as respirators 13, are able to communicate with PPEMS 6. For example, environments 8A and 8B may be configured with wireless technology, such as 802.11 wireless networks, 802.15 ZigBee networks, and the like. In the example of FIG. 1, environment 8B includes a local network 7 that provides a packet-based transport medium for communicating with PPEMS 6 via network 4. In addition, environment 8B includes a plurality of wireless access points 19A, 19B that may be geographically distributed throughout the environment to provide support for wireless communications throughout the work environment.

Each article of PPE, such as respirators 13, is configured to communicate data, such as verification and tracking of inspection of PPE, sensed motions, events and conditions, via wireless communications, such as via 802.11 WiFi protocols, Bluetooth protocol or the like. Articles of PPE, such as respirators 13, may, for example, communicate directly with a wireless access point 19. As another example, each worker 10 may be equipped with a respective one of wearable communication hubs 14A-14M that enable and facilitate communication between articles of PPE, such as respirators 13, and PPEMS 6. For example, articles of PPE, such as respirators 13, for the respective worker 10 may communicate with a respective communication hub 14 via Bluetooth or other short range protocol, and the communication hubs may communicate with PPEMs 6 via wireless communications processed by wireless access points 19. Although shown as wearable devices, hubs 14 may be implemented as stand-alone devices deployed within environment 8B. In some examples, hubs 14 may be articles of PPE. In some examples, communication hubs 14 may be an intrinsically safe computing device, smartphone, wrist- or head-wearable computing device, or any other computing device.

In general, each of hubs 14 operates as a wireless device for articles of PPE, such as respirators 13, relaying communications to and from such articles of PPE, such as respirators 13, and may be capable of buffering usage data in case communication is lost with PPEMS 6. Moreover, each of hubs 14 is programmable via PPEMS 6 so that local alert rules may be installed and executed without requiring a connection to the cloud. As such, each of hubs 14 provides a relay of streams of usage data from articles of PPE, such as respirators 13, within the respective environment, and provides a local computing environment for localized alerting based on streams of events in the event communication with PPEMS 6 is lost.

As shown in the example of FIG. 3, an environment, such as environment 8B, may also include one or more wireless-enabled beacons, such as beacons 17A-17C, that provide accurate location information within the work environment. For example, beacons 17A-17C may be GPS-enabled such that a controller within the respective beacon may be able to precisely determine the position of the respective beacon. Based on wireless communications with one or more of beacons 17, a given article of PPE, such as respirator 13, or communication hub 14 worn by a worker 10 is configured to determine the location of the worker within work environment 8B. In this way, event data (e.g., usage data) reported to PPEMS 6 may be stamped with positional information to aid analysis, reporting and analytics performed by the PPEMS.

In addition, an environment, such as environment 8B, may also include one or more wireless-enabled sensing stations, such as sensing stations 21A, 21B. Each sensing station 21 includes one or more sensors and a controller configured to output data indicative of sensed environmental conditions. Moreover, sensing stations 21 may be positioned within respective geographic regions of environment 8B or otherwise interact with beacons 17 to determine respective positions and include such positional information when reporting environmental data to PPEMS 6. As such, PPEMS 6 may be configured to correlate sensed environmental conditions with the particular regions and, therefore, may utilize the captured environmental data when processing event data received from articles of PPE, such as respirators 13. For example, PPEMS 6 may utilize the environmental data to aid generating alerts or other instructions for articles of PPE, such as respirators 13, and for performing predictive analytics, such as determining any correlations between certain environmental conditions (e.g., heat, humidity, visibility) with abnormal worker behavior or increased safety events. As such, PPEMS 6 may utilize current environmental conditions to aid prediction and avoidance of imminent safety events. Example environmental conditions that may be sensed by sensing stations 21 include but are not limited to temperature, humidity, presence of gas, pressure, visibility, wind and the like.

In example implementations, an environment, such as environment 8B, may also include one or more safety stations 15 distributed throughout the environment to provide viewing stations for accessing articles of PPE, such as respirators 13. Safety stations 15 may allow one of workers to check out articles of PPE, such as respirators 13, verify that safety equipment is appropriate for a particular one of environments 8, perform acoustic or visual inspection of articles of PPE, and/or exchange data. For example, safety stations 15 may transmit alert rules, software updates, or firmware updates to articles of PPE, such as respirators 13. Safety stations 15 may also receive data cached on respirators 13, hubs 14, and/or other safety equipment. That is, while articles of PPE, such as respirators 13 (and/or data hubs 14), may typically transmit usage data from sensors related to articles of PPE, such as respirators 13, to network 4 in real time or near real time, in some instances, articles of PPE, such as respirators 13 (and/or data hubs 14), may not have connectivity to network 4. In such instances, articles of PPE, such as respirators 13 (and/or data hubs 14), may store usage data locally and transmit the usage data to safety stations 15 upon being in proximity with safety stations 15. Safety stations 15 may then upload the data from articles of PPE, such as respirators 13, and connect to network 4. In some examples, a data hub may be an article of PPE.

In addition, each of environments 8 include computing facilities that provide an operating environment for end-worker computing devices 16 for interacting with PPEMS 6 via network 4. For example, each of environments 8 typically includes one or more safety managers responsible for overseeing safety compliance within the environment. In general, each worker 20 may interact with computing devices 16 to access PPEMS 6. Each of environments 8 may include systems. Similarly, remote workers may use computing devices 18 to interact with PPEMS via network 4. For purposes of example, the end-worker computing devices 16 may be laptops, desktop computers, mobile devices such as tablets or so-called smart phones and the like. In the context of inspecting an article of PPE as part of a readiness assessment, in interrogation device is specified in various language in this disclosure. In most embodiments, the interrogation device that is preferred is a smart phone type device that includes an onboard processor, memory, display, as well as a camera for taking digital images or video, and a microphone for audio. Interrogation device, in one embodiment, runs software that embodies a PPE readiness assessment system, and would be used by a user to go through a readiness assessment checklist, as will be described further in the next figure and beyond.

Workers 20, 24 interact with PPEMS 6 to control and actively manage many aspects of safety equipment utilized by workers 10, such as accessing and viewing usage records, analytics and reporting. For example, workers 20, 24 may review usage information acquired and stored by PPEMS 6, where the usage information may include data specifying worker queries to or responses from safety assistants, data specifying starting and ending times over a time duration (e.g., a day, a week, or the like), data collected during particular events, such as lifts of a visor of respirators 13, removal of respirators 13 from a head of workers 10, changes to operating parameters of respirators 13, status changes to components of respirators 13 (e.g., a low battery event), motion of workers 10, detected impacts to respirators 13 or hubs 14, sensed data acquired from the worker, environment data, and the like.

In addition, workers 20, 24 may interact with PPEMS 6 to perform asset tracking and to schedule maintenance events for individual articles of PPE, e.g., respirators 13, to ensure compliance with any procedures or regulations. PPEMS 6 may allow workers 20, 24 to create and complete digital checklists with respect to the maintenance procedures and to synchronize any results of the procedures from computing devices 16, 18 to PPEMS 6.

Further, as described herein, PPEMS 6 integrates an event processing platform configured to process thousand or even millions of concurrent streams of events from digitally enabled PPEs, such as respirators 13. An underlying analytics engine of PPEMS 6 applies historical data and models to the inbound streams to compute assertions, such as identified anomalies or predicted occurrences of safety events based on conditions or behavior patterns of workers 10. Further, PPEMS 6 may provide real-time alerting and reporting to notify workers 10 and/or workers 20, 24 of any predicted events, anomalies, trends, and the like.

The analytics engine of PPEMS 6 may, in some examples, apply analytics to identify relationships or correlations between one or more of queries to or responses from safety assistants, sensed worker data, environmental conditions, geographic regions and/or other factors and analyze the impact on safety events. PPEMS 6 may determine, based on the data acquired across populations of workers 10, which particular activities, possibly within certain geographic region, lead to, or are predicted to lead to, unusually high occurrences of safety events.

In this way, PPEMS 6 tightly integrates comprehensive tools for managing personal protection equipment with an underlying analytics engine and communication system to provide data acquisition, monitoring, activity logging, reporting, behavior analytics and alert generation. Moreover, PPEMS 6 provides a communication system for operation and utilization by and between the various elements of system 2. Workers 20, 24 may access PPEMS 6 to view results on any analytics performed by PPEMS 6 on data acquired from workers 10. In some examples, PPEMS 6 may present a web-based interface via a web server (e.g., an HTTP server) or client-side applications may be deployed for devices of computing devices 16, 18 used by workers 20, 24, such as desktop computers, laptop computers, mobile devices such as smartphones and tablets, or the like.

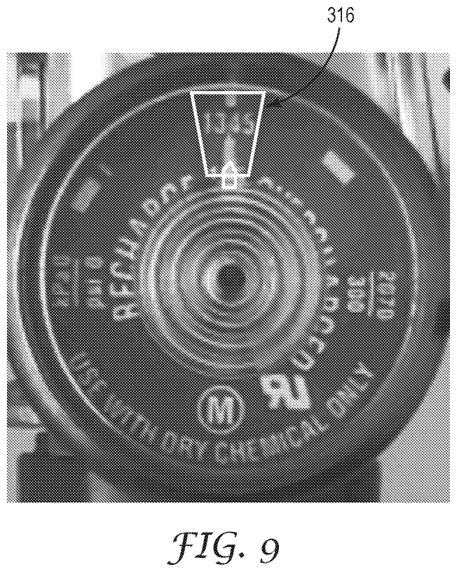

In some examples, PPEMS 6 may provide a database query engine for directly querying PPEMS 6 to view acquired safety information, compliance information, queries to or responses from safety assistants, and any results of the analytic engine, e.g., by the way of dashboards, alert notifications, reports and the like. That is, workers 24, 26, or software executing on computing devices 16, 18, may submit queries to PPEMS 6 and receive data corresponding to the queries for presentation in the form of one or more reports or dashboards (e.g., as shown in the examples of FIGS. 9-16). Such dashboards may provide various insights regarding system 2, such as baseline (“normal”) operation across worker populations, identifications of any anomalous workers engaging in abnormal activities that may potentially expose the worker to risks, identifications of any geographic regions within environments 2 for which unusually anomalous (e.g., high) safety events have been or are predicted to occur, queries to or responses from safety assistants, identifications of any of environments 2 exhibiting anomalous occurrences of safety events relative to other environments, and the like.

As illustrated in detail below, PPEMS 6 may simplify workflows for individuals charged with monitoring and ensure safety compliance for an entity or environment. That is, the techniques of this disclosure may enable active safety management and allow an organization to take preventative or correction actions with respect to certain regions within environments 8, queries to or responses from safety assistants, particular pieces of safety equipment or individual workers 10, and/or may further allow the entity to implement workflow procedures that are data-driven by an underlying analytical engine.

As one example, the underlying analytical engine of PPEMS 6 may be configured to compute and present customer-defined metrics for worker populations within a given environment 8 or across multiple environments for an organization as a whole. For example, PPEMS 6 may be configured to acquire data, including but not limited to queries to or responses from safety assistants, and provide aggregated performance metrics and predicted behavior analytics across a worker population (e.g., across workers 10 of either or both of environments 8A, 8B). Furthermore, workers 20, 24 may set benchmarks for occurrence of any safety incidences, and PPEMS 6 may track actual performance metrics relative to the benchmarks for individuals or defined worker populations. As another example, PPEMS 6 may further trigger an alert if certain combinations of conditions and/or events are present, such as based on queries to or responses from safety assistants. In this manner, PPEMS 6 may identify PPE, environmental characteristics and/or workers 10 for which the metrics do not meet the benchmarks and prompt the workers to intervene and/or perform procedures to improve the metrics relative to the benchmarks, thereby ensuring compliance and actively managing safety for workers 10.

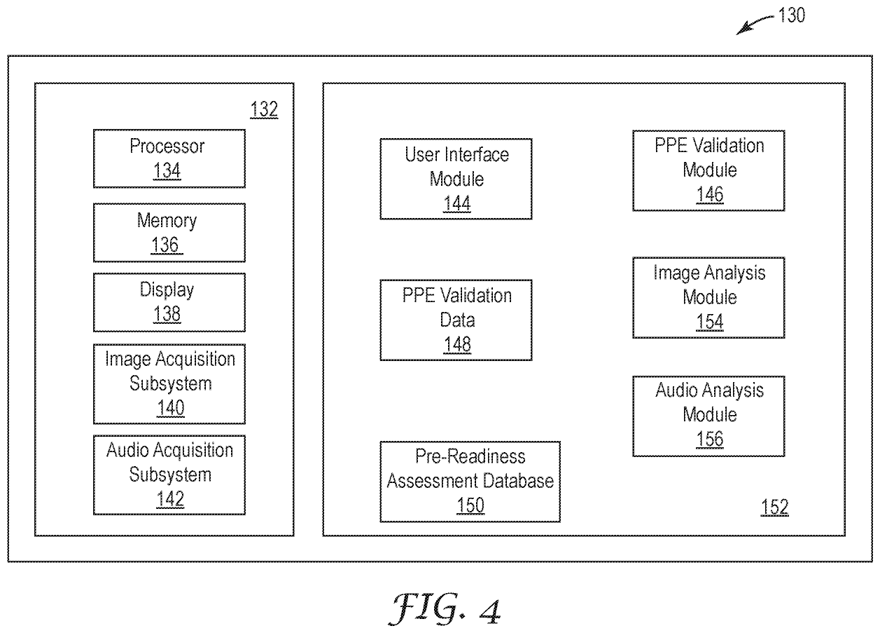

Turning now to FIG. 4, a system diagram of PPE readiness assessment system 130 is shown. The PPE readiness system is preferably deployed as software on device 18 shown in FIG. 3. It may be deployed on any suitable computing device, though preferably a smart phone having a camera and microphone. The device it is deployed on, for the purposes of this disclosure, will be referred to as the interrogation device. It communicates with PPEMS 6, as needed, to manage an entire deployment of PPE in a work environment.

PPE readiness assessment system 130 comprises hardware components 132 that are typical of modern smart phones or computing devices. The hardware components include a processor 134, a memory 136, a display 138, as well as an image acquisition subsystem 140 (such as a camera), and an audio acquisition subsystem 142 (such as a microphone). Additional hardware components may be included in hardware components 132.

Running on a user interface component (not shown in FIG. 4), a number of functional software and storage components 152 comprise instructions and rules that embody the PPE readiness assessment system. A user interface module 144 interfaces with, via the operating system, display 138 (or other hardware components) to provide and receive input from a user, and to drive inspection methodology that is associated with a PPE readiness assessment. The basic logic of the PPE readiness assessment module is embodied within the PPE validation module 146. PPE validation module 146 determines what readiness assessment steps need to be performed on a given article of PPE by looking up an inspection checklist in the PPE readiness assessment database 150. The inspection checklist contains rules and steps a user needs to complete in order to ensure the readiness of an article of PPE. The PPE validation module then prompts a user of the system to start going through the inspection checklist, soliciting input confirming completion of various inspection steps before proceeding to a next inspection step. For some of the steps amenable to validation with a camera or an audio recording, the PPE validation module will cause the user interface module 144 to request that the user take a picture of a particular piece of equipment, or to make an audio recording while the user exercises particular functionality of the PPE. The operating system will then be requested, within the app that is running the PPE validation module, to make available either the image acquisition subsystem 140's or audio acquisition subsystem 143's resources, in order to take a picture or record audio. Resultant data, that is, picture or audio data, is provided to image analysis module 154 or audio analysis module 156 respectively. Image analysis module and audio analysis module may be provided with information from the PPE validation module specifying the type of analysis that is to be done to the picture or audio data, respectively. For example, the PPE validation module may specify that data associated with a given picture is of a particular type of analog pressure valve of the type shown in FIG. 2, and the image analysis module 154 (or in the case of audio, audio analysis module 156) would then apply various appropriate analysis algorithms as will be described further below. PPE validation module 146 will, in conjunction with image analysis module 154 or audio analysis module 156, determine a readiness state associated with an article of PPE. That readiness state may be a state associated with a discrete sensor that is reviewed as a step in the PPE readiness assessment checklist, on the one hand, or may be associated with the overall readiness of the entire PPE, as would be the case when the checklist has been fully completed and there are the inspection has been “passed”, meaning the article of PPE is ready for use (in one embodiment).

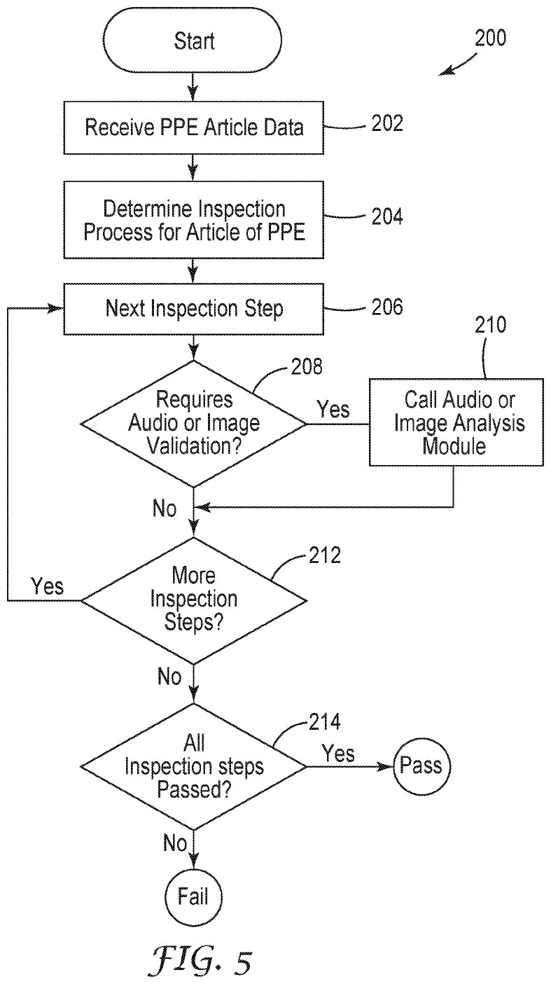

FIG. 5 is a flowchart showing an exemplary PPE inspection algorithm 200, functionally embodied in instructions executed by the hardware shown in FIG. 4 as part of PPE validation module 146 (in conjunction with other software modules and an underlying operating system, as needed). The PPE inspection algorithm is used to ascertain a readiness state of an article of PPE, by the PPE readiness assessment system 130. The inspection process starts with the PPE validation module 146 receiving PPE article data 202. Such data may come from the article of PPE itself, as for example a bar code or QR code, or from a smart tag that is on or associated with a particular article of PPE. With this information, the PPE validation module retrieves the required inspection process from PPE readiness assessment database 150, or from another suitable source (such as entered by a user or otherwise looked up), and ultimately determines the inspection process for the article of PPE (step 204). This inspection process information includes the requisite steps needed to complete a readiness assessment for the particular article of PPE. The steps are then interactively initiated (206), and for each inspection step a determination is made as to whether the inspection step requires (or allows) audio or image validation (decision 208). If yes, the audio or video analysis module, as appropriate, is invoked, using functionality described below (step 210). If not, the process iterates until all inspection steps are complete (decision 212). Eventually, all inspection steps have been completed, and a determination is made as to whether all steps have passed (decision 214). If yes, the readiness assessment has been passed; if no, it has failed. Appropriate indicia may then presented to the user via display 138 vis-à-vis the user interface module 144. For example, if the inspection step was passed, the word “pass” could be displayed, or a similarly indicative icon could be displayed. Alternatively, if the inspection step did not pass, this too could be indicated on the display through a suitable user interface. Additional information concerning non-pass events could also be displayed, for example the reason why the inspection step was not passed. Information concerning the checklist itself, including who carried out the inspection, the date and time of the inspection, the particular article of PPE that was inspected, and how each inspection step was completed (as well as supporting audio and picture data, as needed) may be written to PPE validation data 148, which may comprise a database or other file system. This data may be reviewed later as part of a history associated with a given article of PPE, or may be used for audit purposes, for example.

Image Analysis Module

The image analysis module, as mentioned, interacts with the PPE validation module 146 (in reference to FIG. 4), to analyze an image that is associated with an article of PPE, in order to determine a readiness state of that article of PPE. The image is ideally a photograph captured with the interrogation device, e.g., a smart phone's camera function. The image may be of any particular element of the article of PPE as necessary for inspection purposes, or may comprise the entire article of PPE as required.

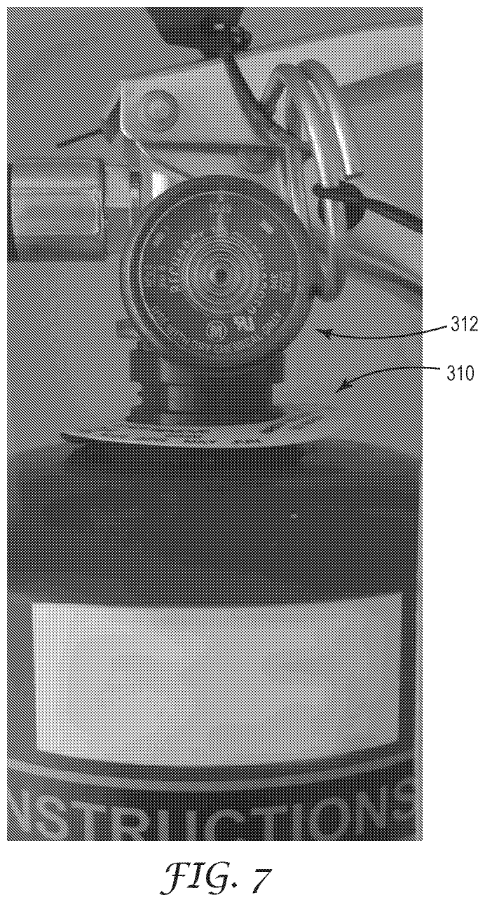

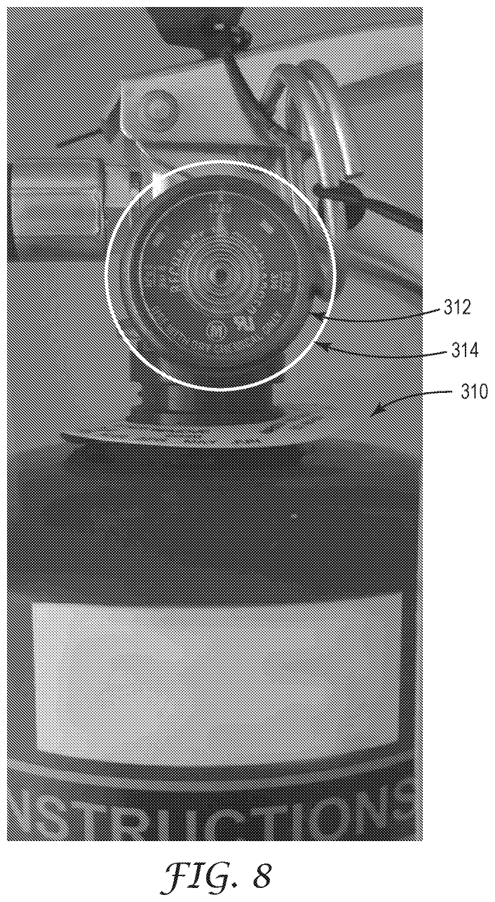

In the example of analyzing an analog pass/fail color gauge, as represented in FIGS. 1 and 2, as Step 208 in the flow chart of FIG. 5, the image analysis module in one embodiment is provided with data indicative of the type of gauge it will be analyzing; that is, data indicating that an expected gauge has a yellow needle, and that the needle over green indicates pass, and/or the needle over red indicates fail. The image analysis module may first interact, ideally via an app on the interrogation device, with the camera on said device to guide the user to line up the gauge with a circle displayed on the screen of the interrogation device before taking a photo. Once the photo is taken, the user either submits the image or indicates, to the interrogation device via an app, that the image that has been acquired is suitable and the process should proceed. Alternatively or additionally, the image analysis module contains some form of trained model that is able to locate and return the exact locations of gauges within an image, for example an object detection neural network such as Faster-RCNN or a Single Shot Detector (SSD), or a more classic object detection method such as Haar Cascades. Training an object detection neural network like Faster-RCNN or SSD first requires many training examples. A training example includes an image, such as a picture with a gauge in it, and a set of coordinates, or bounding box, that encloses an area of interest, in this case the gauge. Ideally, samples differ from each other in size, color, background content, and details in the area of interest. With enough samples, ideally in at least the hundreds, if not many thousands, a suitable neural network such as a convolutional neural network, can be trained or retrained on these samples to detect the features that distinguish the object from background. Regardless of if the module requires a tight bound on a gauge image or is able to take in an entire image with a gauge somewhere in it, the image analysis module receives an image with a gauge to be examined. In either case, as the next step, analysis of the image begins. In one embodiment, the identified gauge is scanned for appropriate color patches, i.e. yellow and green, which are associated with portions of the gauge face itself. If pixels associated with the dial (or needle) is over pixels associated with the dial's indication of “full) (might be, for example, green color patch on the dial), the device inspection has passed; otherwise, the inspection has failed. An example of this progression may be seen in FIGS. 7-9. FIG. 7 shows a cylinder 310 having a dial face 312. FIG. 8 shows additionally a graphic overlay circular indicium 314 which may be provided by the image acquisition subroutine, as part of a graphic user interface, to assist the user in aligning the image acquisition device to the gauge. FIG. 8 shows the resulting image, automatically cropped, and ready for processing, with indicia 316 circumscribing an area associated with the cannister being full. If pixels in this circumscribed area correspond additionally to the presence of a dial, the canister is deemed “full”, and the cannister may in some embodiments be “passed” this portion of an inspection, as further described below. In another embodiment, instead of using rules such as the identification of color patches, the image analysis module uses a trained neural network to categorize a gauge as pass or fail. In such embodiment, the underlying neural network would be trained on many hundreds, if not thousands, of gauges labeled as pass or fail. Such a network would need to be trained on a variety of gauges, such as black or white or other colored background, black or white or colored needles, and a variety of pass or fail states, including gauges that use a PSI percentage to indicate success or failure pass, or a dial simply over a pass or fail background colors, or other gauge types.

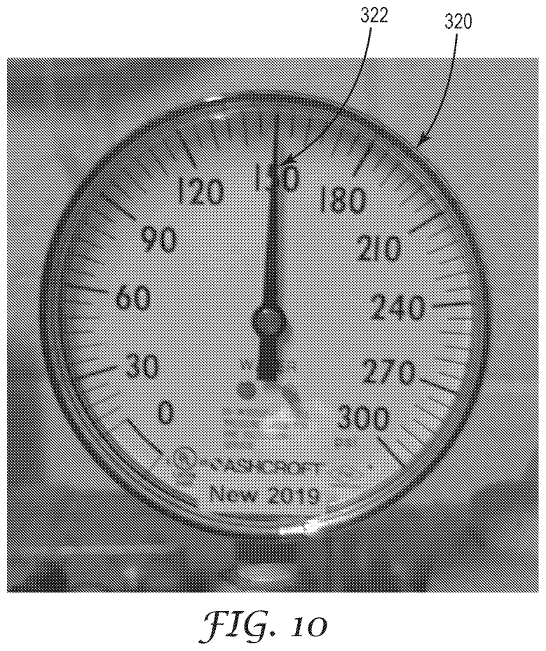

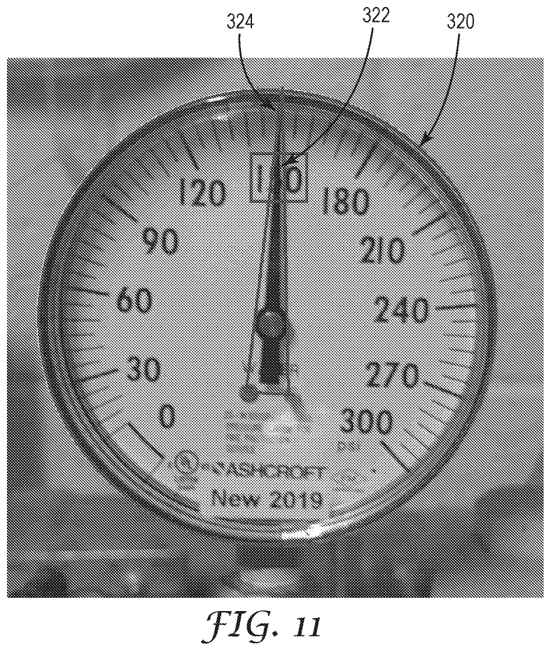

As mentioned, in one embodiment the image analysis module receives or is programmed with data indicative of the type of gauge it will be analyzing, particularly the graphical characteristics of said device. For example, and turning now to FIGS. 10 and 11, the image analysis module programmatically expects that a particular gauge of type “X” has numbered ticks of 0, 30, 60, 90, 120, 150, 180, 210, 240, 270, and 300. Ina situation where there are multiple different types of gauges, a user could assist in providing user input identifying the type of device (a surrogate for the type of expected gauge), or a further processing step may occur that involves identifying the type of device and/or the type of gauge to be analyzed. This could be done by training an image recognition module to identify certain types of devices or gauges. Further identification processes, such as having the user scan a barcode, or even embedding unique indicia of gauge/device type within the field of view of a gauge (such as a small QR code), are also possible. Regardless of the way gauge identification is accomplished, once identified the module may acquire an analysis ruleset associated with that device or gauge (or whatever the thing is that is to be analyzed). Next, the image analysis module scans the acquired image for numbers and for a dial (needle) (i.e., in one routine for the particular gauge shown in FIGS. 10 and 11, the longest black line). FIG. 10 shows a dial gauge face 320 having a various numbers associated with pressure readings around most of its perimeter. Dial 322 is shown pointing at and obscuring the “150” number. In FIG. 11, for illustrative purposes, the image analysis module is seen as having outlined with outline 324 the identified dial. The analysis ruleset in this particular example says that the number the needle obscures, or whichever two numbers the needle falls between, is the gauge reading; thus the image analysis module effectively identifies the needle 322 of FIG. 11. If some minimum and/or maximum threshold was set (i e a minimum of 150, or a minimum of 90 and a maximum of 210) and the dial reads over the minimum, between minimum and maximum, or under maximum, the inspection passes and this aspect of the readiness state of the device is updated; otherwise, the inspection fails. Instead of issuing a pass or fail, the inspection step may simply output the detected number on the gauge.

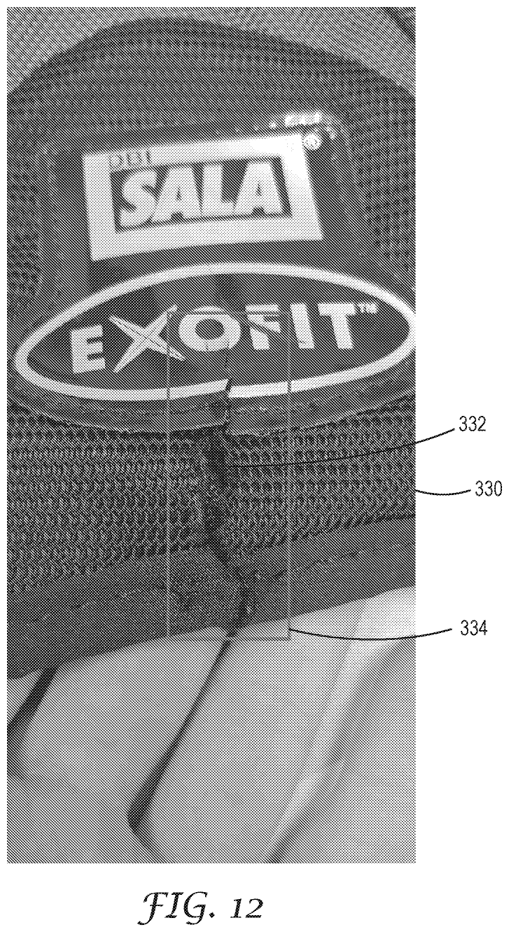

Turning now to a different example, this one of analyzing a fall protection harness or fall protection lanyard for damage, such as a tear, the image analysis module is provided a picture of fall protection gear 330 (FIG. 12), having tear defect 332. The image analysis module in one embodiment uses a trained neural network to differentiate between usable and unusable straps, or look for unbroken lines of canvas. The module can be trained what the threshold is for unusable—for example, in FIG. 12, the tear extends from the outer periphery inward toward the middle of the strap. The image analysis module can mark just the area of concern for a user, such as with alert indicia 334, for further inspection, or mark the area of concern and indicate exactly what makes the harness cut a failed inspection (the portion of the cut that is passed the stitching).

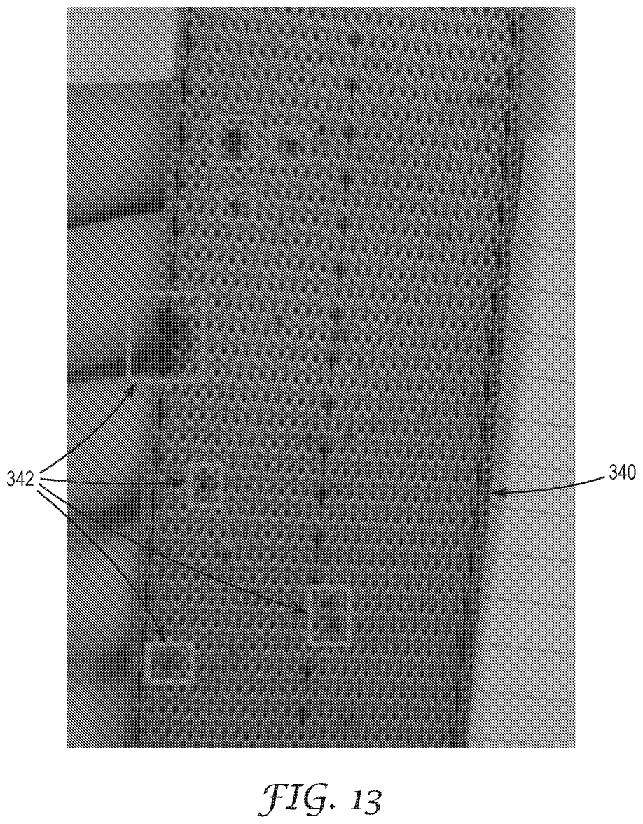

In a further example of analyzing a fall protection harness or fall protection lanyard, the image analysis module is given a picture of fall protection gear (FIG. 13), this time with burn-related defects 342. The image analysis module in one embodiment uses a neural network to differentiate between colors from the item's original manufacturing and discoloration. The module is trained with various defects related to, e.g., burning or sun discoloration. The image analysis module locates discoloration including from burns and can either determine that they exceed a threshold level of defect (and the item does not pass inspection), or indicia 344 can be overlaid on the image to allow a user to do a further inspection and make a determination on the suitability of the PPE for further use. In some embodiments, the image analysis module may further output an estimate of the severity and nature of the damage discovered, for example, “tear, 2 cm”, or “burn, 3 square cm”.

Audio Analysis Module

The audio analysis module, as mentioned, interacts with the PPE validation module 146 (in reference to FIG. 4), to analyze audio data that is associated with an article of PPE, in order to determine a readiness state of that article of PPE.

In one example, the audio analysis module may be configured to verify that a firefighter's Personal Alert Safety System, or PASS alarm, is operational. The United States National Fire Protection Association began setting PASS device standards in 1982. The Personal Alert Safety System is an alarm and motion detection device attached to a firefighter's breathing apparatus used to indicate distress in an emergency. If the motion detection device does not detect motion for 20 seconds, it initiates a pre-alarm sequence; the PASS alarm can also be manually triggered to immediately start the last phase of the alarm. In the event a firefighter is down and stops moving, the alert system will begin to sound, thus broadcasting the firefighter's location. If the downed firefighter is able to move or rescue themselves, they can turn the PASS alert off. If the downed firefighter simply holds still, the PASS alert will continue to sound, allowing other firefighters or emergency personnel to locate the downed firefighter by sound. The PASS alarm is made up of three pre-alarm phases of different tones and volume, each playing for about four seconds, each able to be cancelled with device motion; the PASS alarm also has a fourth and loudest tone and phase that stops only once a user has pressed a button on the PASS device. To pass an inspection, every phase should be heard to ensure the device is working properly. This could be accomplished in at least two ways. A set of rules could be applied that looked through the audio data for specific frequencies or orders of frequencies, or other known acoustic elements. For example, if the acoustic signal is well defined to be a series of beeps, the length, order, timing, and pitch, etc. of the series of beeps could be recognized, and their meaning determined by application of the series of rules. Alternatively, or in addition, a machine learning algorithm could be employed, as discussed next. In a machine learning embodiment of the audio analysis module, the module is first trained on many samples of the full PASS alarm and many samples of partial alarms or other noises, where each sample is composed of appropriate features of the audio signal. In one embodiment, the features used are the mean Mel Frequency Cepstral Coefficient (MFCC) and mean filterbank, which is a common method applied when trying to use computers to interpret speech the way that human ears perceives pitch. The MFCC is generated by taking short, overlapping subsamples, or windows, of the audio signal, applying a Discrete Fourier Transform to each window, taking the logarithm of the magnitude of the signal, warping the frequencies on the Mel scale (a filter, or filterbank, based on how human ears perceive sound, since the human auditory system does not perceive pitch linearly), then applying the inverse Discrete Cosine Transform. The mean filterbank in this case is the mean, or average, of the Mel filterbank features that were also used to generate the MFCC.

The audio analysis module takes as input an audio sample (similarly first converted by the module by extracting the mean MFCC and mean filterbank features) and gives as output a percent confidence of each classification of full PASS alarm or not. The module may use a pre-set threshold to output a simple “contains PASS alarm” or “does not contain PASS alarm” or may output the highest percent confidence and which classification that is, or may output just the percent confidence that the audio sample contained a full PASS alarm.

In a further example of how the audio analysis module may ascertain the readiness state of an article or component of an article, some articles of PPE may include components that are designed to broadcast via acoustic signals information about their readiness state. For example, some articles of PPE allow the user to initiate an article of PPE to do a self-check, and on successful completion, the article of PPE may produce an auditory signal indicative of a successful completion, or a failed completion, of the self-check. As a particular example, some powered air-purifying respirators (PAPRs) sold by 3M Company of St. Paul, MN have several components that can be self-tested. For example, the 3M™ Breathe Easy™ Turbo Powered Air Purifying Respirator can self-check its battery life, battery charge level, various stages of fan blower motor revolutions per minute, blower airflow, unit leaks or internal pressure, and filter life, then uses a text-to-speech engine to alert users to various state-related conditions. The audio analysis module may be trained to recognize the audio hallmarks associated with such a pass or fail self-check, or to understand such communications. For example the Turbo may communicate “battery life is at 57%” which the audio analysis module may suitably convert to data and compare against a readiness threshold, when determining whether the device is ready for deployment. Some PAPRs may use a more rudimentary communications approach: for example, three short beeps means the system was satisfactory or a pass, two short beeps means the system was mostly satisfactory but the battery life is low, a repeating short beep to indicate the system is unsatisfactory, or the like. All of these audio signals associated with PPE readiness state may be received and analyzed by the audio analysis module. A PAPR fan, if working correctly, has a particular noise or audio signature when it runs, and if such sound falls outside of acoustic parameters associated with normal behavior, in one embodiment such a condition could be associated with an inspection “fail” event.

As another example, a hearing protection headset PPE, such as a 3M™ Peltor™ WS LiteCom Pro, may perform self-diagnostics on its digital components, such as checking that its two-way communication radio is operational, or it may check on component expiration date, such as checking if a hearing cushion has reached end of life, if the headset is kept informed of when the cushion has been replaced. In this example, because the headset is already capable of generating feedback in a human voice with words, the interrogation device may listen for an explicit recognition of system pass, such as the headset saying “Self-diagnostics complete. Battery charge is 67%. Ear cushion life expectancy is over 500 hours.” In the case of older headsets which do not speak to the user, the interrogation device may instead listen for a sequence of beeps that indicate the system has booted up and activated; in this case, a failure to hear any beeps from the headset may indicate the system batteries have died, for example.

Once either the image analysis module or the audio analysis module has finished its respective analysis, the PPE readiness assessment system 130 (in reference to FIG. 4) may then determine a readiness state of the article of PPE. For example, if it was determined that a gauge was not sufficiently full, or was otherwise inconsistent with safe usability and readiness, the PPE readiness assessment system may determine that the article of PPE has a readiness state of a particular nature. The readiness state may be defined by management at the site, in one embodiment, and various particular features of the inspection that pass or fail may be given different weights, and other custom logic may be set up as needed. For example, there may be minor things that do not pass inspection, but such things are not enough to mark the entire article of PPE as having a non-ready state. Such things, instead, may be marked for later replacement or further inspection, or the user of the article is simply alerted to them. On the other hand, in some embodiments if any aspect of the inspection fails, the readiness state for the article of PPE is set to be indicative of a state where the article of PPE is not ready for use. Readiness state, as used herein, broadly refers to the readiness of the article of PPE to be safely used as intended in an intended environment.

Once the readiness state has been determined, the PPE readiness assessment system performs a function based on the readiness state. The function may, for example, involve providing indicia (e.g., auditory or visual) on a device that is communicatively coupled to the interrogation device. For example, a user's smart phone may run an app and the readiness state is displayed there, along with the timestamp associated with the last inspection. The function may also involve updating a database or other tracking means with information concerning the readiness state of the article of PPE. This information would then be referenced when checking out articles of PPE to users entering the field, or would be used when removing articles of PPE from active use and sending them in to be subjected to maintenance operations. Other functions are also possible, including for example generating signals causing, or used for, the printing of a tag that may be physically coupled to the article of PPE that includes visual indicia indicative of the readiness state, and potentially other metadata associated with an inspection event. For example, a tag could be generated that indicates the article of PPE was inspected on such-and-such date, and failed the inspection and shouldn't be deployed, and the reason it failed inspection related to a particular strap being frayed. Or, conversely, the article of PPE was last inspected on such-and-such date and successfully passed, and is ready for deployment. The resulting function performed after the readiness assessment is determined may also embody other functions as determined, potentially, by the user or by site management.

Returning now to FIG. 3, client applications executing on interrogation device 18 may be implemented for different platforms but include similar or the same functionality. For instance, a client application may be a desktop application compiled to run on a desktop operating system, such as Microsoft Windows, Apple OS X, or Linux, to name only a few examples. As another example, a client application may be a mobile application compiled to run on a mobile operating system, such as Google Android, Apple iOS, Microsoft Windows Mobile, or BlackBerry OS to name only a few examples.

As another example, this time where the PPE readiness assessment system is deployed in a client-server type architecture, a client application may be a web application such as a web browser that displays web pages received from PPEMS 6 (in such case, the PPE validation module 146 may be implemented on PPEMS 6). In such an embodiment, PPEMS 6 may receive requests from the web application related to an PPE readiness assessment (via a web browser on the interrogation device), process the requests, and send one or more responses back to the web application. In this way, the collection of web pages, the client-side processing web application, and the server-side processing performed by PPEMS 6 collectively provides the functionality to perform techniques of this disclosure. In this way, client applications use various services of PPEMS 6 in accordance with techniques of this disclosure, and the applications may operate within various different computing environment (e.g., embedded circuitry or processor of a PPE, a desktop operating system, mobile operating system, or web browser, to name only a few examples).

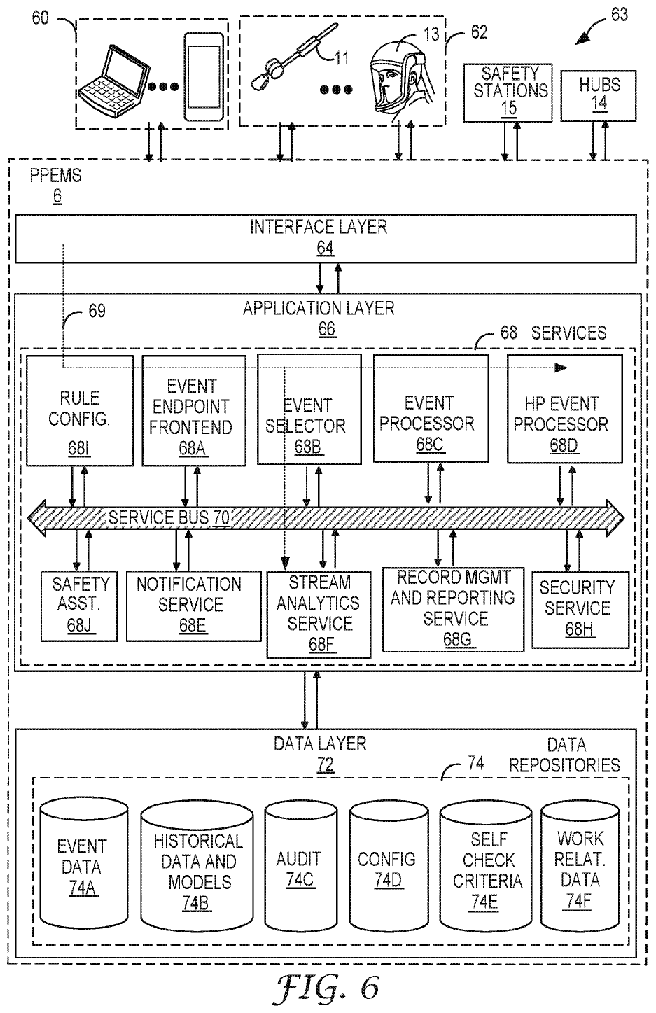

Turning now to FIG. 6, PPEMS 6, a further description for PPMS is shown. Some embodiments described in this disclosure may not rely on a PPEMS 6, or may rely on simplified versions of it. PPEMS 6 in one embodiment includes an interface layer 64 that represents a set of application programming interfaces (API) or protocol interface presented and supported by PPEMS 6. Interface layer 64 initially receives messages from any of clients 63 for further processing at PPEMS 6. Interface layer 64 may therefore provide one or more interfaces that are available to client applications executing on clients 63. In some examples, the interfaces may be application programming interfaces (APIs) that are accessible over a network. Interface layer 64 may be implemented with one or more web servers. The one or more web servers may receive incoming requests, process and/or forward information from the requests to services 68, and provide one or more responses, based on information received from services 68, to the client application that initially sent the request. In some examples, the one or more web servers that implement interface layer 64 may include a runtime environment to deploy program logic that provides the one or more interfaces. As further described below, each service may provide a group of one or more interfaces that are accessible via interface layer 64.

In some examples, interface layer 64 may provide Representational State Transfer (RESTful) interfaces that use HTTP methods to interact with services and manipulate resources of PPEMS 6. In such examples, services 68 may generate JavaScript Object Notation (JSON) messages that interface layer 64 sends back to the client application 61 that submitted the initial request. In some examples, interface layer 64 provides web services using Simple Object Access Protocol (SOAP) to process requests from client applications 61. In still other examples, interface layer 64 may use Remote Procedure Calls (RPC) to process requests from clients 63. Upon receiving a request from a client application to use one or more services 68, interface layer 64 sends the information to application layer 66, which includes services 68.

As shown in FIG. 6, PPEMS 6 also includes an application layer 66 that represents a collection of services for implementing much of the underlying operations of PPEMS 6. Application layer 66 receives information included in requests received from client applications 61 and further processes the information according to one or more of services 68 invoked by the requests. Application layer 66 may be implemented as one or more discrete software services executing on one or more application servers, e.g., physical or virtual machines. That is, the application servers provide runtime environments for execution of services 68. In some examples, the functionality interface layer 64 as described above and the functionality of application layer 66 may be implemented at the same server.

Application layer 66 may include one or more separate software services 68, e.g., processes that communicate, e.g., via a logical service bus 70 as one example. Service bus 70 generally represents a logical interconnections or set of interfaces that allows different services to send messages to other services, such as by a publish/subscription communication model. For instance, each of services 68 may subscribe to specific types of messages based on criteria set for the respective service. When a service publishes a message of a particular type on service bus 70, other services that subscribe to messages of that type will receive the message. In this way, each of services 68 may communicate information to one another. As another example, services 68 may communicate in point-to-point fashion using sockets or other communication mechanism Before describing the functionality of each of services 68, the layers are briefly described herein.

Data layer 72 of PPEMS 6 represents a data repository that provides persistence for information in PPEMS 6 using one or more data repositories 74. A data repository, generally, may be any data structure or software that stores and/or manages data. Examples of data repositories include but are not limited to relational databases, multi-dimensional databases, maps, and hash tables, to name only a few examples. Data layer 72 may be implemented using Relational Database Management System (RDBMS) software to manage information in data repositories 74. The RDBMS software may manage one or more data repositories 74, which may be accessed using Structured Query Language (SQL). Information in the one or more databases may be stored, retrieved, and modified using the RDBMS software. In some examples, data layer 72 may be implemented using an Object Database Management System (ODBMS), Online Analytical Processing (OLAP) database or other suitable data management system.

As shown in FIG. 6, each of services 68A-68I (“services 68”) is implemented in a modular form within PPEMS 6. Although shown as separate modules for each service, in some examples the functionality of two or more services may be combined into a single module or component. Each of services 68 may be implemented in software, hardware, or a combination of hardware and software. Moreover, services 68 may be implemented as standalone devices, separate virtual machines or containers, processes, threads or software instructions generally for execution on one or more physical processors.

In some examples, one or more of services 68 may each provide one or more interfaces that are exposed through interface layer 64. Accordingly, client applications of computing devices 60 may call one or more interfaces of one or more of services 68 to perform techniques of this disclosure.

Services 68 may include an event processing platform including an event endpoint frontend 68A, event selector 68B, event processor 68C and high priority (HP) event processor 68D. Event endpoint frontend 68A operates as a front end interface for receiving and sending communications to articles of PPE 62 and hubs 14. In other words, event endpoint frontend 68A may in some embodiments operate as a front line interface to safety equipment deployed within environments 8 and utilized by workers 10. In some instances, event endpoint frontend 68A may be implemented as a plurality of tasks or jobs spawned to receive individual inbound communications of event streams 69 from the articles of PPE 62 carrying data sensed and captured by the safety equipment. When receiving event streams 69, for example, event endpoint frontend 68A may spawn tasks to quickly enqueue an inbound communication, referred to as an event, and close the communication session, thereby providing high-speed processing and scalability. Each incoming communication may, for example, carry data recently captured data representing sensed conditions, motions, temperatures, actions or other data, generally referred to as events. Communications exchanged between the event endpoint frontend 68A and the PPEs may be real-time or pseudo real-time depending on communication delays and continuity.

Event selector 68B operates on the stream of events 69 received from articles of PPE 62 and/or hubs 14 via frontend 68A and determines, based on rules or classifications, priorities associated with the incoming events. For instance, a query to a safety assistant with a higher priority may be routed by high priority event processor 68D in accordance with the query priority. Based on the priorities, event selector 68B enqueues the events for subsequent processing by event processor 68C or high priority (HP) event processor 68D. Additional computational resources and objects may be dedicated to HP event processor 68D so as to ensure responsiveness to critical events, such as incorrect usage of articles of PPE, use of incorrect filters and/or respirators based on geographic locations and conditions, failure to properly secure SRLs 11, failure to perform required PPE inspection steps, readiness state (such as whether an article of PPE is ready to be used by worker) of articles of PPE, and the like. Responsive to processing high priority events, HP event processor 68D may immediately invoke notification service 68E to generate alerts, instructions, warnings, responses, or other similar messages to be output to SRLs 11, respirators 13, hubs 14 and/or remote workers 20, 24. Events not classified as high priority are consumed and processed by event processor 68C.

In general, event processor 68C or high priority (HP) event processor 68D operate on the incoming streams of events to update event data 74A within data repositories 74. In general, event data 74A may include all or a subset of usage data obtained from PPEs 62. For example, in some instances, event data 74A may include entire streams of samples of data obtained from electronic sensors of PPEs 62. In other instances, event data 74A may include a subset of such data, e.g., associated with a particular time period or activity of articles of PPE 62.

Event processors 68C, 68D may create, read, update, and delete event information stored in event data 74A. These invents may be inspection-related events, or results of readiness assessments, or may feed as inputs into readiness assessments. Event information may be stored in a respective database record as a structure that includes name/value pairs of information, such as data tables specified in row/column format. For instance, a name (e.g., column) may be “worker ID” and a value may be an employee identification number. An event record may include information such as, but not limited to: worker identification, PPE identification, acquisition timestamp(s) and data indicative of one or more sensed parameters.

In addition, event selector 68B in some embodiments directs the incoming stream of events to stream analytics service 68F, which is configured to perform in depth processing of the incoming stream of events to perform real-time analytics. In other embodiments, analysis may be done near real time, or it may be done after the fact. Stream analytics service 68F may, for example, be configured to process and compare multiple streams of event data 74A with historical data and models 74B in real-time as event data 74A is received. In this way, stream analytic service 68D may be configured to detect anomalies, transform incoming event data values, trigger alerts upon detecting safety concerns based on conditions or worker behaviors. Historical data and models 74B may include, for example, specified safety rules, business rules and the like. In addition, stream analytic service 68D may generate output for communicating to PPEs 62 by notification service 68F or computing devices 60 by way of record management and reporting service 68D. In some examples, events processed by event processors 68C-68D may be safety events or may be events other than safety events.

In this way, analytics service 68F processes inbound streams of events, potentially hundreds or thousands of streams of events, from enabled safety articles of PPE 62 utilized by workers 10 within environments 8 to apply historical data and models 74B to compute assertions, such as identified anomalies or predicted occurrences of imminent safety events based on conditions or behavior patterns of the workers. Analytics service may 68D publish responses, messages, or assertions to notification service 68F and/or record management by service bus 70 for output to any of clients 63.

In this way, analytics service 68F may be configured as an active safety management system that determines whether required PPE inspection steps are complete, determines a PPE readiness state, determines when a readiness assessment should be initiated for an article of PPE, predicts imminent safety concerns, responds to queries for safety assistants, and provides real-time alerting and reporting. In addition, analytics service 68F may be a decision support system that provides techniques for processing inbound streams of event data to generate assertions in the form of statistics, conclusions, and/or recommendations on an aggregate or individualized worker, articles of PPE and/or PPE-relevant areas for enterprises, safety officers and other remote workers. For instance, analytics service 68F may apply historical data and models 74B to determine, for a particular worker or article of PPE query or response to a safety assistant, the likelihood that required PPE inspection steps are complete, the likelihood that an article of PPE is in a readiness state, or a safety event is imminent for the worker based on detected behavior or activity patterns, environmental conditions and geographic locations. In some examples, analytics service 68F may determine, such as based on a query or response for a safety assistant, whether an article of PPE is ready to be used by a worker, whether required PPE inspection steps are complete for an article of PPE, and/or whether a worker is currently impaired, e.g., due to exhaustion, sickness or alcohol/drug use, and may require intervention to prevent safety events. As yet another example, analytics service 68F may provide comparative ratings of workers or type of safety equipment in a particular environment 8, such as based on a query or response for a safety assistant.

In some embodiments, analytics service 68F may maintain or otherwise use one or more models or risk metrics that provide PPE readiness state determinations or predict safety events. Analytics service 68F may also generate order sets, recommendations, and quality measures. In some examples, analytics service 68F may generate worker interfaces based on processing information stored by PPEMS 6 to provide actionable information to any of clients 63. For example, analytics service 68F may generate dashboards, alert notifications, reports and the like for output at any of clients 63. Such information may provide various insights regarding baseline (“normal”) operation across worker populations, identifications of any anomalous workers engaging in abnormal activities that may potentially expose the worker to risks, identifications of any geographic regions within environments for which unusually anomalous (e.g., high) safety events have been or are predicted to occur, identifications of any of environments exhibiting anomalous occurrences of safety events relative to other environments, identification of articles of PPE that are not in use readiness state(s), and the like, any of a which may be based on queries or responses for a safety assistant.

Although other technologies can be used, in one example implementation, analytics service 68F utilizes machine learning when operating on streams of safety events so as to perform real-time, near real time, or after-the-fact analytics. That is, analytics service 68F includes executable code generated by application of machine learning to training data of event streams and known safety events to detect patterns, such as based on a query or response for a safety assistant. The executable code may take the form of software instructions or rule sets and is generally referred to as a model that can subsequently be applied to event streams 69 for detecting similar patterns, predicting upcoming events, or the like.

Analytics service 68F may, in some examples, generate separate models for a particular article of PPE or groups of like articles of PPE, a particular worker, a particular population of workers, a particular or generalized query or response for a safety assistant, a particular environment, or combinations thereof. Analytics service 68F may update the models based on usage data received from articles PPE 62. For example, analytics service 68F may update the models for a particular worker, particular or generalized query or response for a safety assistant, a particular population of workers, a particular environment, or combinations thereof based on data received from articles of PPE 62. In some examples, usage data may include PPE readiness state data based on at least one of acoustic or visual properties corresponding to an article of PPE, incident reports, air monitoring systems, manufacturing production systems, or any other information that may be used to a train a model.

Alternatively, or in addition, analytics service 68F may communicate all or portions of the generated code and/or the machine learning models to hubs 14 (or articles of PPE 62) for execution thereon so as to provide local alerting in near-real time to articles of PPE. Example machine learning techniques that may be employed to generate models 74B can include various learning styles, such as supervised learning, unsupervised learning, and semi-supervised learning. Example types of algorithms include Bayesian algorithms, Clustering algorithms, decision-tree algorithms, regularization algorithms, regression algorithms, instance-based algorithms, artificial neural network algorithms, deep learning algorithms, dimensionality reduction algorithms and the like. Various examples of specific algorithms include Bayesian Linear Regression, Boosted Decision Tree Regression, and Neural Network Regression, Back Propagation Neural Networks, the Apriori algorithm, K-Means Clustering, k-Nearest Neighbour (kNN), Learning Vector Quantization (LVQ), Self-Organizing Map (SOM), Locally Weighted Learning (LWL), Ridge Regression, Least Absolute Shrinkage and Selection Operator (LASSO), Elastic Net, and Least-Angle Regression (LARS), Principal Component Analysis (PCA) and Principal Component Regression (PCR).

Record management and reporting service 68G processes and responds to messages and queries received from computing devices 60 via interface layer 64. For example, record management and reporting service 68G may receive requests from client computing devices for event data related to readiness state of articles of PPE, individual workers, populations or sample sets of workers, geographic regions of environments 8 or environments 8 as a whole, individual or groups/types of articles of PPE 62. In response, record management and reporting service 68G accesses event information based on the request. Upon retrieving the event data, record management and reporting service 68G constructs an output response to the client application that initially requested the information. In some examples, the data may be included in a document, such as an HTML document, or the data may be encoded in a JSON format or presented by a dashboard application executing on the requesting client computing device. For instance, as further described in this disclosure, example worker interfaces that include the event information are depicted in the figures.

As additional examples, record management and reporting service 68G may receive requests to find, analyze, and correlate PPE event information, including queries or responses for a safety assistant. For instance, record management and reporting service 68G may receive a query request from a client application for event data 74A over a historical time frame, such as a worker can view PPE event information over a period of time and/or a computing device can analyze the PPE event information over the period of time.

In example implementations, services 68 may also include security service 68H that authenticate and authorize workers and requests with PPEMS 6. Specifically, security service 68H may receive authentication requests from client applications and/or other services 68 to access data in data layer 72 and/or perform processing in application layer 66. An authentication request may include credentials, such as a workername and password. Security service 68H may query security data 74A to determine whether the workername and password combination is valid. Configuration data 74D may include security data in the form of authorization credentials, policies, and any other information for controlling access to PPEMS 6. As described above, security data 74A may include authorization credentials, such as combinations of valid workernames and passwords for authorized workers of PPEMS 6. Other credentials may include device identifiers or device profiles that are allowed to access PPEMS 6.

Security service 68H may provide audit and logging functionality for operations performed at PPEMS 6. For instance, security service 68H may log operations performed by services 68 and/or data accessed by services 68 in data layer 72, including queries or responses for a safety assistant. Security service 68H may store audit information such as logged operations, accessed data, and rule processing results in audit data 74C. In some examples, security service 68H may generate events in response to one or more rules being satisfied. Security service 68H may store data indicating the events in audit data 74C.

In the example of FIG. 6, a safety manager may initially configure one or more safety rules. As such, remote worker 24 may provide one or more worker inputs at computing device 18 that configure a set of safety rules for work environment 8A and 8B. For instance, a computing device 60 of the safety manager may send a message that defines or specifies the safety rules. Such message may include data to select or create conditions and actions of the safety rules. PPEMS 6 may receive the message at interface layer 64 which forwards the message to rule configuration component 68I. Rule configuration component 68I may be combination of hardware and/or software that provides for rule configuration including, but not limited to: providing a worker interface to specify conditions and actions of rules, receive, organize, store, and update rules included in safety rules data store 74E.

Safety rules data store 75E may be a data store that includes data representing one or more safety rules. Safety rules data store 74E may be any suitable data store such as a relational database system, online analytical processing database, object-oriented database, or any other type of data store. When rule configuration component 68I receives data defining safety rules from computing device 60 of the safety manager, rule configuration component 68I may store the safety rules in safety rules data store 75E.

In some examples, storing the safety rules may include associating a safety rule with context data, such that rule configuration component 68I may perform a lookup to select safety rules associated with matching context data. Context data may include any data describing or characterizing the properties or operation a worker, worker environment, article of PPE, or any other entity, including queries or responses for a safety assistant. Context data of a worker may include, but is not limited to: a unique identifier of a worker, type of worker, role of worker, physiological or biometric properties of a worker, experience of a worker, training of a worker, time worked by a worker over a particular time interval, location of the worker, PPE readiness state data for articles PPE used by a particular worker, or any other data that describes or characterizes a worker, including content of queries or responses for a safety assistant. Context data of an article of PPE may include, but is not limited to: a unique identifier of the article of PPE; a type of PPE of the article of PPE; required inspection steps for article of PPE; readiness data (such as, use readiness data) for article of PPE; a usage time of the article of PPE over a particular time interval; a lifetime of the PPE; a component included within the article of PPE; a usage history across multiple workers of the article of PPE; contaminants, hazards, or other physical conditions detected by the PPE, expiration date of the article of PPE; operating metrics of the article of PPE. Context data for a work environment may include, but is not limited to: a location of a work environment, a boundary or perimeter of a work environment, an area of a work environment, hazards within a work environment, physical conditions of a work environment, permits for a work environment, equipment within a work environment, owner of a work environment, responsible supervisor and/or safety manager for a work environment.

According to aspects of this disclosure, the rules and/or context data may be used for purposes of reporting, to generate alerts, detecting safety events, or the like. In an example for purposes of illustration, worker 10A may be equipped with at least one article of PPE, such as respirator 13A, and data hub 14A. Respirator 13A may include a filter to remove particulates but not organic vapors. Data hub 14A may be initially configured with and store a unique identifier of worker 10A. When initially assigning the respirator 13A and data hub to worker 10A, a computing device operated by worker 10A and/or a safety manager may cause RMRS 68G to store a mapping in work relation data 74F. Work relation data 74F may include mappings between data that corresponds to PPE, workers, and work environments. Work relation data 74F may be any suitable datastore for storing, retrieving, updating and deleting data. RMRS 69G may store a mapping between the unique identifier of worker 10A and a unique device identifier of data hub 14A. Work relation data store 74F may also map a worker to an environment.

In some examples, PPEMS 6 may additionally or alternatively apply analytics to predict the likelihood of a safety event or the need for a readiness assessment for a particular article of PPE. As noted above, a safety event may refer to activities of a worker using PPE 62, queries or responses for a safety assistant, a condition of PPE 62, or a hazardous environmental condition (e.g., that the likelihood of a safety event is relatively high, that the environment is dangerous, that SRL 11 is malfunctioning, that one or more components of SRL 11 need to be repaired or replaced, or the like). For example, PPEMS 6 may determine the likelihood of a safety event based on application of usage data from PPE 62 and/or queries or responses for a safety assistant to historical data and models 74B. That is, PPEMS 6 may apply historical data and models 74B to usage data from respirators 13 and/or queries or responses for a safety assistant in order to compute assertions, such as anomalies or predicted occurrences of imminent safety events based on environmental conditions or behavior patterns of a worker using a respirator 13.

PPEMS 6 may apply analytics to identify relationships or correlations between sensed data from respirators 13, queries or responses for a safety assistant, environmental conditions of environment in which respirators 13 are located, a geographic region in which respirators 13 are located, and/or other factors. PPEMS 6 may determine, based on the data acquired across populations of workers 10, which particular activities, possibly within certain environment or geographic region, lead to, or are predicted to lead to, unusually high occurrences of safety events. PPEMS 6 may generate alert data based on the analysis of the usage data and transmit the alert data to PPEs 62 and/or hubs 14. Hence, according to aspects of this disclosure, PPEMS 6 may determine usage data associated with articles of PPE, generate status indications, determine performance analytics, and/or perform prospective/preemptive actions based on a likelihood of a safety event.

Usage data from PPEs 62 and/or queries or responses for a safety assistant may be used to determine usage statistics. For example, PPEMS 6 may determine, based on usage data from respirators 13 or a safety assistant, a length of time that one or more components of respirator 13 (e.g., head top, blower, and/or filter) have been in use, an instantaneous velocity or acceleration of worker 10 (e.g., based on an accelerometer included in respirators 13 or hubs 14), a temperature of one or more components of respirator 13 and/or worker 10, a location of worker 10, a number of times or frequency with which a worker 10 has performed a self-check of respirator 13 or other PPE, a number of times or frequency with which a visor of respirator 13 has been opened or closed, a filter/cartridge consumption rate, fan/blower usage (e.g., time in use, speed, or the like), battery usage (e.g., charge cycles), or the like.

PPEMS 6 may use the usage data to characterize activity of worker 10. For example, PPEMS 6 may establish patterns of productive and nonproductive time (e.g., based on operation of respirator 13 and/or movement of worker 10), categorize worker movements, identify key motions, and/or infer occurrence of key events, which may be based on queries or responses for a safety assistant. That is, PPEMS 6 may obtain the usage data, analyze the usage data using services 68 (e.g., by comparing the usage data to data from known activities/events), and generate an output based on the analysis, such as by using queries or responses for a safety assistant.

One or more of the examples in this disclosure may use usage statistics and/or usage data. In some examples, the usage statistics may be used to determine when PPE 62 is in need of maintenance or replacement. For example, PPEMS 6 may compare the usage data to data indicative of normally operating respirators 13 in order to identify defects or anomalies. In other examples, PPEMS 6 may also compare the usage data to data indicative of a known service life statistics of respirators 13. The usage statistics may also be used to provide an understanding how PPE 62 are used by workers 10 to product developers in order to improve product designs and performance. In still other examples, the usage statistics may be used to gather human performance metadata to develop product specifications. In still other examples, the usage statistics may be used as a competitive benchmarking tool. For example, usage data may be compared between customers of respirators 13 to evaluate metrics (e.g. productivity, compliance, or the like) between entire populations of workers outfitted with respirators 13.

Usage data from respirators 13 may be used to determine status indications. For example, PPEMS 6 may determine that a visor of a PPE 62 is up in hazardous work area. PPEMS 6 may also determine that a worker 10 is fitted with improper equipment (e.g., an improper filter for a specified area), or that a worker 10 is present in a restricted/closed area. PPEMS 6 may also determine whether worker temperature exceeds a threshold, e.g., in order to prevent heat stress. PPEMS 6 may also determine when a worker 10 has experienced an impact, such as a fall.

Usage data from respirators 13 may be used to assess performance of worker 10 wearing PPE 62. For example, PPEMS 6 may, based on usage data from respirators 13, recognize motion that may indicate a pending fall by worker 10 (e.g., via one or more accelerometers included in respirators 13 and/or hubs 14). In some instances, PPEMS 6 may, based on usage data from respirators 13, infer that a fall has occurred or that worker 10 is incapacitated. PPEMS 6 may also perform fall data analysis after a fall has occurred and/or determine temperature, humidity and other environmental conditions as they relate to the likelihood of safety events.

As another example, PPEMS 6 may, based on usage data from respirators 13, recognize motion that may indicate fatigue or impairment of worker 10. For example, PPEMS 6 may apply usage data from respirators 13 to a safety learning model that characterizes a motion of a worker of at least one respirator. In this example, PPEMS 6 may determine that the motion of a worker 10 over a time period is anomalous for the worker 10 or a population of workers 10 using respirators 13.

Usage data from respirators 13 may be used to determine alerts and/or actively control operation of respirators 13. For example, PPEMS 6 may determine that a safety event such as equipment failure, a fall, or the like is imminent PPEMS 6 may send data to respirators 13 to change an operating condition of respirators 13. In an example for purposes of illustration, PPEMS 6 may apply usage data to a safety learning model that characterizes an expenditure of a filter of one of respirators 13. In this example, PPEMS 6 may determine that the expenditure is higher than an expected expenditure for an environment, e.g., based on conditions sensed in the environment, usage data gathered from other workers 10 in the environment, or the like. PPEMS 6 may generate and transmit an alert to worker 10 that indicates that worker 10 should leave the environment and/or active control of respirator 13. For example, PPEMS 6 may cause respirator to reduce a blower speed of a blower of respirator 13 in order to provide worker 10 with substantial time to exit the environment.

PPEMS 6 may generate, in some examples, a warning when worker 10 is near a hazard in one of environments 8 (e.g., based on location data gathered from a location sensor (GPS or the like) of respirators 13). PPEMS 6 may also applying usage data to a safety learning model that characterizes a temperature of worker 10. In this example, PPEMS 6 may determine that the temperature exceeds a temperature associated with safe activity over the time period and alert worker 10 to the potential for a safety event due to the temperature.

In another example, PPEMS 6 may schedule preventative maintenance or automatically purchase components for respirators 13 based on usage data. For example, PPEMS 6 may determine a number of hours a blower of a respirator 13 has been in operation, and schedule preventative maintenance of the blower based on such data. PPEMS 6 may automatically order a filter for respirator 13 based on historical and/or current usage data from the filter.

Again, PPEMS 6 may determine the above-described performance characteristics and/or generate the alert data based on application of the usage data to one or more safety learning models that characterizes activity of a worker of one of respirators 13. The safety learning models may be trained based on historical data or known safety events. However, while the determinations are described with respect to PPEMS 6, as described in greater detail herein, one or more other computing devices, such as hubs 14 or respirators 13 may be configured to perform all or a subset of such functionality.

In some examples, a safety learning model is trained using supervised and/or reinforcement learning techniques. The safety learning model may be implemented using any number of models for supervised and/or reinforcement learning, such as but not limited to, an artificial neural networks, a decision tree, naïve Bayes network, support vector machine, or k-nearest neighbor model, to name only a few examples. In some examples, PPEMS 6 initially trains the safety learning model based on a training set of metrics and corresponding to safety events. In some examples, the training set may include or is based on queries or responses for a safety assistant. The training set may include a set of feature vectors, where each feature in the feature vector represents a value for a particular metric. As further example description, PPEMS 6 may select a training set comprising a set of training instances, each training instance comprising an association between usage data and a safety event. The usage data may comprise one or more metrics that characterize at least one of a worker, a work environment, or one or more articles of PPE. PPEMS 6 may, for each training instance in the training set, modify, based on particular usage data and a particular safety event of the training instance, the safety learning model to change a likelihood predicted by the safety learning model for the particular safety event in response to subsequent usage data applied to the safety learning model. In some examples, the training instances may be based on real-time or periodic data generated while PPEMS 6 managing data for one or more articles of PPE, workers, and/or work environments. As such, one or more training instances of the set of training instances may be generated from use of one or more articles of PPE after PPEMS 6 performs operations relating to the detection or prediction of a safety event for PPE, workers, and/or work environments that are currently in use, active, or in operation.

In some instances, PPEMS 6 may apply analytics for combinations of PPE. For example, PPEMS 6 may draw correlations between workers of respirators 13 and/or the other PPE (such as fall protection equipment, head protection equipment, hearing protection equipment, or the like) that is used with respirators 13. That is, in some instances, PPEMS 6 may determine the likelihood of a safety event based not only on usage data from respirators 13, but also from usage data from other PPE being used with respirators 13, which may include queries or responses for a safety assistant. In such instances, PPEMS 6 may include one or more safety learning models that are constructed from data of known safety events from one or more devices other than respirators 13 that are in use with respirators 13.

In some examples, a safety learning model is based on safety events from one or more of a worker, article of PPE, and/or work environment having similar characteristics (e.g., of a same type), which may include queries or responses for a safety assistant. In some examples the “same type” may refer to identical but separate instances of PPE. In other examples the “same type” may not refer to identical instances of PPE. For instance, although not identical, a same type may refer to PPE in a same class or category of PPE, same model of PPE, or same set of one or more shared functional or physical characteristics, to name only a few examples. Similarly, a same type of work environment or worker may refer to identical but separate instances of work environment types or worker types. In other examples, although not identical, a same type may refer to a worker or work environment in a same class or category of worker or work environment or same set of one or more shared behavioral, physiological, environmental characteristics, to name only a few examples.

In some examples, to apply the usage data to a model, PPEMS 6 may generate a structure, such as a feature vector, in which the usage data is stored. The feature vector may include a set of values that correspond to metrics (e.g., characterizing PPE, worker, work environment, queries or responses for a safety assistant, to name a few examples), where the set of values are included in the usage data. The model may receive the feature vector as input, and based on one or more relations defined by the model (e.g., probabilistic, deterministic or other functions within the knowledge of one of ordinary skill in the art) that has been trained, the model may output one or more probabilities or scores that indicate likelihoods of safety events based on the feature vector.

In general, while certain techniques or functions are described herein as being performed by certain components, e.g., PPEMS 6, respirators 13, or hubs 14, it should be understood that the techniques of this disclosure are not limited in this way. That is, certain techniques described herein may be performed by one or more of the components of the described systems. For example, in some instances, respirators 13 may have a relatively limited sensor set and/or processing power. In such instances, one of hubs 14 and/or PPEMS 6 may be responsible for most or all of the processing of usage data, determining the likelihood of a safety event, and the like. In other examples, respirators 13 and/or hubs 14 may have additional sensors, additional processing power, and/or additional memory, allowing for respirators 13 and/or hubs 14 to perform additional techniques. Determinations regarding which components are responsible for performing techniques may be based, for example, on processing costs, financial costs, power consumption, or the like. In other examples any functions described in this disclosure as being performed at one device (e.g., PPEMS 6, PPE 62, and/or computing devices 60, 63) may be performed at any other device (e.g., PPEMS 6, PPE 62, and/or computing devices 60, 63).

Embodiments described herein include, without limitation:

Embodiment A. A personal protection equipment (PPE) interrogation device, comprising:
a processor;
a memory; and,
an audio or visual sensor that receives sensor input associated with an article of PPE and produces sensor data representative of the sensor input;
wherein the interrogation device executes instructions which cause the processor to:
receive sensor data;
analyze the sensor data using the processor to determine a readiness state of an article of PPE; and,
perform a function based on the readiness state.

Embodiment B. The interrogation device of embodiment A, wherein the interrogation device additionally comprises a display, and wherein the performed function comprises executing instructions which cause the processor additionally to:
provide to a user of the interrogation device indicia of the readiness state of the article of PPE.

Embodiment C. The interrogation device of Embodiment A, wherein the performed function comprises executing instructions which cause the processor additionally to:
provide a user of another communicatively coupled device indicia of the readiness state of the article of PPE.

Embodiment D. The interrogation device of Embodiment A, wherein the interrogation device comprises a smart phone, and the instructions embody an app running on the smart phone.

Embodiment E. The interrogation device of Embodiment B, wherein the readiness state is indicative of the article of PPE having failed an inspection step.

Embodiment F. The interrogation device of Embodiment B, wherein the performed function comprises executing instructions which cause the processor to:
write to a log file in the memory information indicative of the readiness state of the article of PPE.

Embodiment G. The interrogation device of Embodiment B, wherein the sensor input comprises an image of an element of an article of PPE.

Embodiment H. The interrogation device of Embodiment G, wherein analyze comprises applying a ruleset to the image to identify characteristics the picture, then determining if the characteristics are consistent with a defined readiness states of the article of PPE.

Embodiment I. The interrogation device of Embodiment G, wherein analyze comprises applying a machine learning model to the image.

Embodiment J. The interrogation device of Embodiment I, wherein the machine learning model has instructions which cause the processor to provide data indicative of whether the picture of the element is associated with a positive readiness state for that element.

Embodiment K. The interrogation device of Embodiment J, wherein the processor determines the readiness state of the article of PPE based on the data indicative of whether the picture of the element is associated with a positive readiness state for that element.

Embodiment L. The interrogation device of Embodiment K, wherein the image comprises a picture of a strap coupled to the article of PPE.

Embodiment M. The interrogation device of Embodiment K, wherein the image comprises a picture of a gauge coupled to the article of PPE

Embodiment N. The interrogation device of Embodiment L, wherein the readiness state for the strap comprises a determination of whether the strap is damaged.

Embodiment O. The interrogation device of Embodiment B, wherein the sensor input comprises audio data associated with functionality of an element of the article of PPE, from a recording device communicatively coupled to the interrogation device.

Embodiment P. The interrogation device of Embodiment O, wherein analyze comprises applying a rule set to the audio data to identify characteristics of the audio data, then determining if the characteristics are consistent with a defined readiness state of the element of the article of PPE.

Embodiment Q. The interrogation device of Embodiment O, wherein analyze comprises applying a machine learning model to the audio data.

Embodiment R. The interrogation device of Embodiment Q, wherein the machine learning model has instructions which cause the processor to provide data indicative of whether the audio data is associated with a positive readiness state for the element.

Embodiment S. The interrogation device of Embodiment R, wherein the element comprises a retractable lanyard, and the audio data is associated with the lanyard's retraction.

Embodiment T. The interrogation device of Embodiment R, wherein the element comprises a processing unit associated with the article of PPE, and the audio data is associated with a self-check fun by the processing unit.

Embodiment U. Methods that embody the process described in Embodiments A through T, in a computer having a processor and memory.

Embodiment V. Systems having a personal protection equipment (PPE) readiness assessment module, which comprises instructions which may be executed on a computer having memory which cause the processor to receive data indicative of image or audio data associated with an element of an article of PPE, analyze the received data by applying a machine learning algorithm, and based on the analyze step, determine a readiness state of the article of PPE.

Although techniques of this disclosure have been described with computing device 302 providing a second set of utterances generated by the safety assistant, in other examples, the safety assistant may perform one or more operations without generating the second set of utterances. For example, a computing device may receive audio data that represents a set of utterances that represents at least one expression of the worker. The computing device may determine, based on applying natural language processing to the set of utterances, safety response data. The computing device may perform at least one operation based at least in part on the safety response data. Accordingly, the computing device may perform any operations described in this disclosure or otherwise suitable in response to a set of utterances that represents at least one expression of the worker, such as but not limited to: configuring PPE, sending messages to other computing devices, or performing any other operations.

In the present detailed description of the preferred embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized, and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “proximate,” “distal,” “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below, or beneath other elements would then be above or on top of those other elements.

As used herein, when an element, component, or layer for example is described as forming a “coincident interface” with, or being “on,” “connected to,” “coupled with,” “stacked on” or “in contact with” another element, component, or layer, it can be directly on, directly connected to, directly coupled with, directly stacked on, in direct contact with, or intervening elements, components or layers may be on, connected, coupled or in contact with the particular element, component, or layer, for example. When an element, component, or layer for example is referred to as being “directly on,” “directly connected to,” “directly coupled with,” or “directly in contact with” another element, there are no intervening elements, components or layers for example. The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and do not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random-access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor”, as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

In some examples, a computer-readable storage medium includes a non-transitory medium. The term “non-transitory” indicates, in some examples, that the storage medium is not embodied in a carrier wave or a propagated signal. In certain examples, a non-transitory storage medium stores data that can, over time, change (e.g., in RAM or cache).

Various examples have been described. These and other examples are within the scope of the following claims.

1. A personal protection equipment (PPE) interrogation device, comprising:
a processor;
a memory; and,
an audio or visual sensor that receives sensor input associated with an article of PPE and produces sensor data representative of the sensor input;
wherein the interrogation device executes instructions which cause the processor to:
receive sensor data;
analyze the sensor data using the processor to determine a readiness state of an article of PPE; and,
perform a function based on the readiness state.

2. The interrogation device of claim 1, wherein the interrogation device additionally comprises a display, and wherein the performed function comprises executing instructions which cause the processor additionally to:
provide to a user of the interrogation device indicia of the readiness state of the article of PPE.

3. The interrogation device of claim 1, wherein the performed function comprises executing instructions which cause the processor additionally to:
provide a user of another communicatively coupled device indicia of the readiness state of the article of PPE.

4. The interrogation device of claim 1, wherein the interrogation device comprises a smart phone, and the instructions embody an app running on the smart phone.

5. The interrogation device of claim 2, wherein the readiness state is indicative of the article of PPE having failed an inspection step.

6. The interrogation device of claim 2, wherein the performed function comprises executing instructions which cause the processor to:
write to a log file in the memory information indicative of the readiness state of the article of PPE.

7. The interrogation device of claim 2, wherein the sensor input comprises an image of an element of an article of PPE.

8. The interrogation device of claim 7, wherein analyze comprises applying a ruleset to the image to identify characteristics the picture, then determining if the characteristics are consistent with a defined readiness states of the article of PPE.

9. The interrogation device of claim 7, wherein analyze comprises applying a machine learning model to the image.

10. The interrogation device of claim 9, wherein the machine learning model has instructions which cause the processor to provide data indicative of whether the picture of the element is associated with a positive readiness state for that element.

11. The interrogation device of claim 10, wherein the processor determines the readiness state of the article of PPE based on the data indicative of whether the picture of the element is associated with a positive readiness state for that element.

12. The interrogation device of claim 11, wherein the image comprises a picture of a strap coupled to the article of PPE.

13. The interrogation device of claim 11, wherein the image comprises a picture of a gauge coupled to the article of PPE

14. The interrogation device of claim 12, wherein the readiness state for the strap comprises a determination of whether the strap is damaged.

15. The interrogation device of claim 2, wherein the sensor input comprises audio data associated with functionality of an element of the article of PPE, from a recording device communicatively coupled to the interrogation device.

16-20. (canceled)

21. A method of determining a readiness state of an article of personal protection equipment (PPE), comprising:
receiving, into a computer having a processor and a memory, element data, associated with an element of the article of PPE;
analyzing, with the processor, the element data;
based on the analysis, determining, using the processor, if the element data is consistent with a defined readiness state of the article of PPE; and,
generating instructions which perform a function based on whether the element data was determined to be consistent.

22. The method of claim 21, wherein the element data comprises audio or image data.

23. The method of claim 21, wherein element data comprises image data, and wherein analyzing comprises applying a machine learning algorithm to the image data.

24. The method of claim 23, wherein applying the machine learning algorithm to the image data provides data indicative of whether the element is likely associated with an element that is consistent with the defined readiness state.

25. The method of claim 21, wherein the element data comprises audio data, and wherein analyzing comprises applying a machine learning algorithm to the audio data.

26. (canceled)

27. (canceled)
